(19) United States
(12) Patent Application Publication
(10) Pub. No.: US 2026/0206756 A1
(43) Pub. Date: Jul. 23, 2026

(54) COMPOUNDS AND METHODS OF TREATING OR PREVENTING A BACTERIAL INFECTION IN A PLANT

(71) Applicant: Ohio State Innovation Foundation, Columbus, OH (US)

(72) Inventors: Gireesh RAJASHEKARA, Wooster, OH (US); Sally MILLER, Wooster, OH (US); Loic DEBLAIS, Durham, NC (US); Sochina RANJIT, Columbus, OH (US); Francesca ROTONDO, Wooster, OH (US)

(21) Appl. No.: 19/157,871

(22) PCT Filed: Feb. 28, 2024
(86) PCT No.: PCT/US24/17607

§ 371 Date: Aug. 19, 2025

Related U.S. Application Data
(60) Provisional application No. 63/487,334, filed on Feb. 28, 2023.

(51) Int. Cl. A01N 43/46; A01N 43/38; A01N 43/42; A01N 43/56; A01N 63/27; A01P 1/00

(52) U.S. Cl. CPC A01N 43/46; A01N 43/38; A01N 43/42; A01N 43/56; A01N 63/27; A01P 1/00

(57) ABSTRACT

The present disclosure relates to compounds and methods of treating or preventing a bacterial infection in a plant, for example, for treatment and prevention of leaf spot disease.

### CROSS-REFERENCE TO RELATED APPLICATIONS

This application claims priority to, and the benefit of, U.S. Provisional Patent Application No. 63/487,334, filed Feb. 28, 2023, which is incorporated by reference herein in its entirety.

### STATEMENT REGARDING FEDERALLY SPONSORED RESEARCH

This invention was made with government support under a Specialty Crops Research Initiative (SCRI) project grant no. 2019-51181-30010/project accession no. 1020301 awarded by the United States Department of Agriculture. The Government has certain rights in the invention.

### FIELD

The present disclosure relates to compounds and methods of treating or preventing a bacterial infection in a plant.

### BACKGROUND

Leaf spot diseases are a group of plant diseases caused by emerging seed-borne phytopathogens. The most common causes of bacterial leaf spot disease of Solanaceous plants are bacteria in the genera Pseudomonas and Xanthomonas causing Pseudomonas leaf spot (PLS) or Xanthomonas leaf spot (XLS, or bacterial leaf spot disease (BLS)). These pathogens are seed borne in many plant species. PLS disease is caused by Pseudomonas syringae pv. syringae (Pss). Pss infection severely reduces the marketable yield of peppers in favorable environmental conditions and causes significant economic losses. The intensive use of copper-sulfate and streptomycin-sulfate to control PLS and other bacterial diseases is associated with antimicrobial-resistant Pss strains, making these control methods less effective. Hence, there is an urgent need to develop antimicrobials effective against Pss in plants. Small molecule (SM) inhibitors or antimicrobials are ideal candidates against bacteria that cause leaf spot disease as they can be effective against multi-drug resistant bacteria.

Given the limitations of ineffective antimicrobial treatments against leaf spot diseases, there is need to address the aforementioned problems by developing improved methods to control or prevent leaf spot disease in plants. The compounds and methods disclosed herein address these and other needs.

### SUMMARY

The present disclosure provides compounds and methods to treat or prevent a bacterial infection in a plant, for example, for treatment and prevention of leaf spot disease.

In one aspect, disclosed herein is a method of treating or preventing a bacterial infection in a plant, the method comprising administering to the plant an effective amount of at least one compound selected from the following:

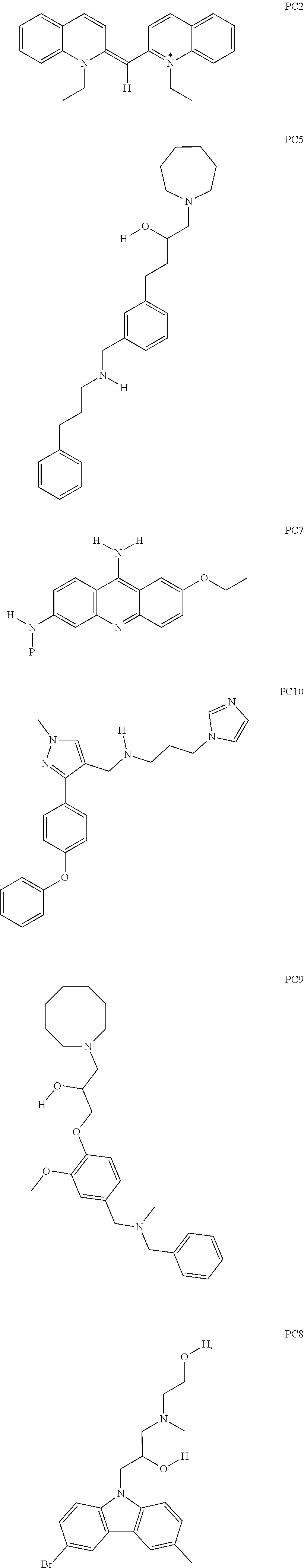

or a derivative thereof.

In some embodiments, the compound comprises PC2. In some embodiments, the compound comprises PC5. In some embodiments, the compound comprises PC7. In some embodiments, the compound comprises PC8. In some embodiments, the compound comprises PC9. In some embodiments, the compound comprises PC10.

In some embodiments, the bacterial infection comprises a bacterial pathogen infesting a seed, a seedling, or a developing plant. In some embodiments, the bacterial infection causes a leaf spot disease. In some embodiments, bacterial infection causes a Pseudomonas leaf spot disease or a Xanthomonas leaf spot disease.

In some embodiments, the bacterial pathogen is selected from the group consisting of strains or pathovars of Agrobacterium tumefaciens, Erwinia amylovora, Erwinia tracheiphilia, Pseudomonas syringae, Pantoea stewartii, Pectobacterium carotovororum, Serratia marcescens, Xanthomonas campestris, Xanthomonas cucurbitae, Xanthomonas hortorum, and Xanthomonas euvesicatoria.

In some embodiments, the bacterial pathogen comprises Pseudomonas syringae pv. syringae (Pss).

In some embodiments, the seed, seedling, or developing plant are selected from the group consisting of Solanaceae, Leguminosae, Rutaceae, and Rosaceae.

In some embodiments, the compound is administered in combination with a beneficial bacteria. In some embodiments, the beneficial bacteria are selected from group consisting of Pseudomonas chlororaphis, Pseudomonas fluorescens, and Pseudomonas protegens.

In some embodiments, the plant is a vegetable, fruit, flower, tree, shrub, grass, or grain. In some embodiments, the plant is a pepper. In some embodiments, the plant is a tomato.

The present disclosure also provides methods of using inhibitors to treat or prevent a leaf spot disease in a plant.

In one aspect, disclosed herein is a method of treating or preventing a leaf spot disease in a plant, the method comprising administering to the plant an effective amount of at least one compound selected from the following:

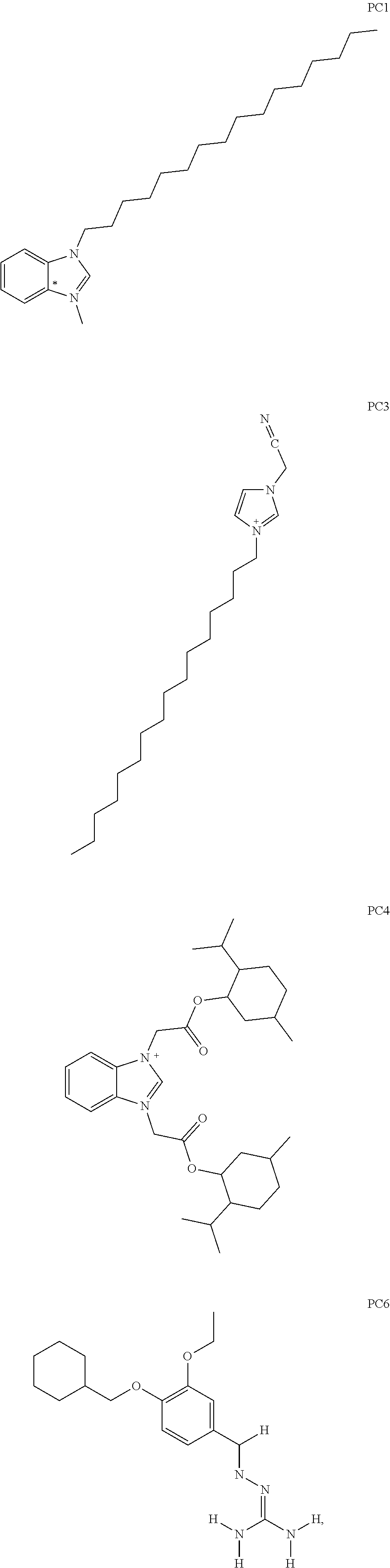

or a derivative thereof, wherein the leaf spot disease is a Pseudomonas leaf spot disease or a Xanthomonas leaf spot disease.

In some embodiments, the compound comprises PC1. In some embodiments, the compound comprises PC3. In some embodiments, the compound comprises PC4. In some embodiments, the compound comprises PC6.

In some embodiments, the leaf spot disease comprises a bacterial pathogen infesting a seed, a seedling, or a developing plant.

In some embodiments, the bacterial pathogen comprises Pseudomonas syringae pv. syringae (Pss). In some embodiments, the seed, seedling, or developing plant are selected from the group consisting of Solanaceae, Leguminosae, Rutaceae, and Rosaceae.

In some embodiments, the compound is administered in combination with a beneficial bacteria. In some embodiments, the beneficial bacteria is selected from the group consisting of Pseudomonas chlororaphis, Pseudomonas fluorescens, and Pseudomonas protegens.

In some embodiments, the plant is a vegetable, fruit, flower, tree, shrub, grass, or grain. In some embodiments, the plant is a pepper. In some embodiments, the plant is a tomato.

### BRIEF DESCRIPTION OF FIGURES

The accompanying figures, which are incorporated in and constitute a part of this specification, illustrate several aspects described below.

FIG. 1 shows the bactericidal, bacteriostatic, and inhibitory hits identified from primary screening against Pseudomonas syringae pv. syringae (Pss) SM1042-14R. The ability of 4,182 small molecules (at 200 μM concentration) to inhibit growth of Pss SM1042-14R was assessed in vitro through kinetic OD₆₀₀ measurement for 48 h using a Tecan Sunrise Absorbance microplate reader. Bacteriostatic activity was determined by assessing the kinetic OD₆₀₀ measurement; Pss compounds (PCs) showing at least 95% growth inhibition were considered bacteriostatic hits. Bactericidal activity was determined by checking for viable colonies after 48 h of PC exposure. A total of 141 small molecules showed at least 70% inhibition (hits). Fifteen PCs were bactericidal (red dots), twelve PCs were bacteriostatic (blue dots), and the rest of the hits (n=110) indicated by black dots were PCs that inhibited at least 70% of SM1042-14R growth.

FIG. 2 shows the dose response assay of 15 small molecule compounds (PC1-PC15) against Pseudomonas syringae pv. syringae (Pss) SM1042-14R. A range of concentrations (6.25 μM to 500 μM) was tested against Pss SM1042-14R in M9 minimal broth for 48 h to determine the inhibitory effects of the PCs and to select the most inhibitory PCs using a Tecan Sunrise Absorbance microplate reader. Blue indicates bactericidal PCs, orange indicates bacteriostatic PCs, and gray indicates PCs that did not inhibit growth at the given concentration.

FIGS. 3A and 3B show heatmaps showing the spectrum of activity of each of 15 small molecule inhibitors (PC1-15) against pathogenic (n=21) and beneficial (n=12) phytobacteria. Bacteria were challenged with 1×MBC (Minimal Bactericidal Concentration) of PCs, within the range of 6.25 μM to 500 μM, and incubated for 48 h at 28° C. in 50% nutrient broth yeast extract (NBY) broth. FIG. 3A shows a heatmap showing the spectrum of activity of each of the PCs against beneficial phytobacteria. FIG. 3B shows a heatmap showing the spectrum of activity against each of the 15 PCs against pathogenic phytobacteria. Red boxes indicate bactericidal effects based on cell viability by plating after the incubation period. The blue boxes indicate no impact on the growth of the bacteria based on optical density measurement.

FIG. 4 shows the effect on germination rate of ‘California Wonder’ pepper seeds 14 days post treatment with each of ten selected compounds (PC1-PC10; 200 μM). Seeds were sown on 1% water agar in glass vials, supplemented with 200 μM of PCs. Seeds treated with 2% DMSO, streptomycin (200 μg/ml), CuSO₄ (200 μM), 2% 2,4-D (herbicide) or 1.2% thymol were used as controls. Thymol and 2,4-D caused significantly higher toxicity on seeds (P<0.01). The data shown are the average from two independent experiments with eight replicates per treatment group in each experiment. The red asterisk represents treatment groups that have significantly lower rates of germination than compared to the DMSO-treated controls. The error bars represent standard deviation from the mean.

FIG. 5 shows the toxicity of ten selected compounds (PC1-PC10) on human Caco-2 cells (n=4) treated with 200 μM concentration of PCs for 24 h. Cytotoxicity was assessed by measuring the release of LDH (lactate dehydrogenase) using a colorimetric CyQUANT LDH Cytotoxicity Assay. Cells treated with 2% DMSO or 10× Lysis buffer were used as controls. The 10× lysis was the positive control that caused significantly higher % cytotoxicity than compared to the DMSO-treated controls (P<0.01). The experiment was conducted twice with two replicates in each experiment; the average percentage of cytotoxicity data from the two trials is represented in the figure. The error bars represent standard deviation of the means, and the red asterisk represents treatment groups that have significantly higher % cytotoxicity than compared to the DMSO-treated controls.

FIG. 6 shows the toxicity of ten selected inhibitory small molecule compounds (PC1-PC10) on pollinator honeybees over 48 h. Adult honeybees were exposed to lul of PCs (200 μM) topically on the thoracic notum. The PCs caused minimal toxicity to the honeybees. The insecticide thiamethoxan caused significantly higher toxicity on honeybees than the DMSO-treated controls (P<0.01). The experiment was conducted twice with 40 honeybees for each treatment group in total; the average percentage mortality from the two trials is shown in the figure. The error bar represents standard deviation of the mean, and the red asterisk indicates the treatment group that had significantly higher % mortality rate in honeybees than the DMSO-treated controls. The dotted line represents the 10% mortality mark that the US Environmental Protection Agency (EPA) considers as minimal toxicity.

FIGS. 7A, 7B, 7C, and 7D show the efficacy of ten selected inhibitory small molecule compounds (PC1-PC10) at 200 μM on Pseudomonas syringae pv. syringae (Pss) SM1042-14R-inoculated pepper seedings 7 days post inoculation (dpi). Some PCs significantly reduced the bacterial load as well as the disease severity on the seedlings compared to the DMSO-treated controls (P<0.01). FIG. 7A shows the disease severity (number of lesions per two leaves) of Pss-inoculated seedlings treated curatively with PCs (1 dpi). FIG. 7B shows the effect of PCs applied curatively (1 dpi) on bacterial load of Pss 7 dpi. FIG. 7C shows the disease severity of Pss-inoculated seedlings treated with PCs preventatively (1 day prior to Pss inoculation). FIG. 7D shows the effect of PCs applied preventatively (1 day prior to Pss inoculation) on bacterial load of Pss 7 dpi. The bars represent the median Log (CFU/gram), and the red asterisk indicates treatment groups that have significantly lower bacterial load or disease severity than the DMSO-treated controls. Two trials were conducted with seven replicates per treatment group. Data are only from the first trial; the second trial showed similar trends, but the bacterial load and disease severity overall were lower than observed in the first trial (FIG. 15).

FIGS. 8A, 8B, 8C, 8D, and 8E show the effect of ten selected compounds (PC1-PC10) at 200 μM on Pseudomonas syringae pv. syringae (Pss) SM1042-14R load in infested pepper seeds at different time points (TP) after seed infestation with Pss SM1042-14R (days). Most PCs (n=8/10) significantly reduced the bacterial load specifically at later TPs (TP20 (D) and TP30 (E)) compared to the DMSO-treated controls. Effect of PCs on Pss populations in infested seeds at A, TP1; B, TP3; C, TP10; D, TP20; E, TP30. The black bars represent the median Log (CFU/gram) of Pss SM1042-14R, and the red asterisk indicates treatment groups that have significantly lower bacterial load than the DMSO-treated controls. Two trials were conducted with five replicates per treatment group; the average bacterial load in Log (CFU/gram) from the two trials is represented.

FIG. 9 shows the chemical structures and functional groups of ten selected bactericidal small molecule compounds identified in this study. PC1-PC10 were clustered into six functional groups using the PubChem website. Cluster A (PC1, PC4, P3 and P10): benzimidazole/imidazole, Cluster B (PC9 and PC5): [methoxyphenoxy]propan-2-ol, Cluster C (PC6): guanidine, Cluster D (PC2): quinoline, Cluster E (PC7): acridine, and Cluster F (PC8): dibromocarbazole.

FIG. 10 shows the growth of ten Pseudomonas syringae pv. syringae (Pss) strains in M9 minimal broth over 48 h at 28° C. Growth curves were plotted with the optical density (OD₆₀₀) data that was measured at 600 nm every 15 min, against time (min). The experiment was conducted twice with three replicates each.

FIG. 11 shows the spectrum of activity of ten selected compounds (PCs) against animal, foodborne, and plant pathogens (n=9) at 100 μM to 200 μM SM. The data were obtained from multiple screening experiments done previously in our laboratory using the same small molecules library (n=4,182). The blue boxes indicate that the PCs do not affect the growth of the bacteria and the red boxes indicate that the PCs were bactericidal against the bacteria.

FIG. 12 shows the effect on root and shoot length (cm) of ‘California Wonder’ pepper seedings 14 days post treatment with one of ten selected compounds (PC1-PC1; 200 μM). Seeds were sown on 1% water agar in glass vials supplemented with 200 μM of each PC. Seeds treated with 2% DMSO, streptomycin (200 μg/ml), CuSO₄ (200 μM), 2% 2,4-D (herbicide) or 1.2% thymol were used as controls. Thymol and 2,4-D caused significantly higher toxicity on seeds (P<0.01). The data shown are averages from two independent experiments with four replicates per treatment group in each experiment. The red asterisk represents treatment groups that have significantly lower root or shoot length than compared to the DMSO-treated group. The error bars represent standard deviation from the means.

FIG. 13 shows the toxicity of ten selected compounds (PCs) on pepper seedling cotyledons (‘California Wonder’) 7 days post treatment. Cotyledons of 14-day old pepper seedlings were treated with 50 μl of 200 μM PCs (PC1-PC10) and incubated at room temperature for 7 days (eight seedling per treatment group). Seedlings treated with 2% DMSO, streptomycin (200 μg/ml), CuSO₄ (200 μM), 2% 2,4-D herbicide or 1.2% thymol were used as controls. None of the PCs caused necrotic or chlorotic symptoms on the cotyledons of the seedlings, however PC2 changed the color of the seedlings to red. The 2% 2,4-D and 1.2% thymol treatment caused necrotic or chlorotic symptoms on the cotyledons of the seedlings. The experiment was conducted twice.

FIG. 14 shows the toxicity of ten selected compounds (PCs) on green organic ‘Sunset’ sweet bell pepper fruit 7 days post treatment. The surface of pepper fruits was treated with 5 ul of 200 μM PCs (PC1-PC10) and incubated at room temperature for 7 days. Pepper fruits treated with 2% DMSO, CuSO₄ (200 μM), 2% 2,4D-herbicide or 1.2% thymol were used as controls. There was no toxicity of the PCs on the fruits of bell peppers, however the 2% 2,4-D and 1.2% thymol caused chlorosis and deformation of the fruit surface. Toxicity of the PCs was tested on yellow and orange organic ‘Sunset’ sweet bell peppers as well, with the same results as shown above. The experiment was conducted twice.

FIGS. 15A, 15B, 15C, and 15D show the second of two trials testing the efficacy of ten selected compounds (PC1-PC10) at 200 μM concentration on Pseudomonas syringae pv. syringae (Pss) SM1042-14R-infected pepper seedings 7 dpi (curative and preventative methods). Some PCs significantly reduced the bacterial load as well as disease severity on the seedlings. A, Disease severity of Pss-inoculated seedlings treated with SMs applied curatively (1 dpi). B, Effect of PCs applied curatively (1 dpi) on bacterial load of Pss at 7 dpi. C, Disease severity of Pss-inoculated seedlings treated preventatively (1 day prior to Pss inoculation). D, Effect of PCs applied preventatively (1 day prior to Pss inoculation) on bacterial load of Pss at 7 dpi. The black bars represent the median Log (CFU/gram), and the red asterisk represents treatment groups that have significantly lower bacterial load or disease severity than the DMSO-treated group. For each group there were seven replicates.

FIG. 16 shows a diagram of methodology workflow of identifying small molecule inhibitors to control Pseudomonas Leaf Spot Disease on pepper plants.

FIG. 17 shows a diagram of the drug discovery workflow of identifying small molecule inhibitors to control Pseudomonas leaf spot disease.

FIG. 18 shows a schematic showing bactericidal vs. bacteriostatic results.

FIGS. 19A and 19B show that most small molecules (SM) have no impact on the growth of beneficial bacteria indicating controlling leaf spot disease in the presence of both SM and beneficial biocontrol phytobacteria combined. FIG. 19B shows that most (SM) were bactericidal against numerous phytopathogens indicating that these SMs can also be used to mitigate multiple pathogens in peppers and other crops.

FIG. 20 shows a principal component analysis factoring in the efficacy data and specificity data. Ideal SMs are clustered into the green circle with narrow spectrum of activity with high efficiency.

### DETAILED DESCRIPTION

The following description of the disclosure is provided as an enabling teaching of the disclosure in its best, currently known embodiment(s). To this end, those skilled in the relevant art will recognize and appreciate that many changes can be made to the various embodiments of the invention described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference will now be made in detail to the embodiments of the invention, examples of which are illustrated in the drawings and the examples. This invention may, however, be embodied in many different forms and should not be construed as limited to the embodiments set forth herein.

### Terminology

Unless defined otherwise, all technical and scientific terms used herein have the same meaning as commonly understood to one of ordinary skill in the art to which this disclosure belongs. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

The following definitions are provided for the full understanding of terms used in this specification.

The terms “about” and “approximately” are defined as being “close to” as understood by one of ordinary skill in the art. In one non-limiting embodiment the terms are defined to be within 10%. In another non-limiting embodiment, the terms are defined to be within 5%. In still another non-limiting embodiment, the terms are defined to be within 1%.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

“Comprising” is intended to mean that the compositions, methods, etc. include the recited elements, but do not exclude others. “Consisting essentially of” when used to define compositions and methods, shall mean including the recited elements, but excluding other elements of any essential significance to the combination. Thus, a composition consisting essentially of the elements as defined herein would not exclude trace contaminants from the isolation and purification method and pharmaceutically acceptable carriers, such as phosphate buffered saline, preservatives, and the like. “Consisting of” shall mean excluding more than trace elements of other ingredients and substantial method steps for administering the compositions provided and/or claimed in this disclosure. Embodiments defined by each of these transition terms are within the scope of this disclosure.

An “increase” can refer to any change that results in a greater amount of a symptom, disease, composition, condition, or activity. An increase can be any individual, median, or average increase in a condition, symptom, activity, composition in a statistically significant amount. Thus, the increase can be a 1, 2, 3, 4, 5, 6, 7, 8, 9, 10, 15, 20, 25, 30, 35, 40, 45, 50, 55, 60, 65, 70, 75, 80, 85, 90, 95, 100% or more increase so long as the increase is statistically significant.

A “decrease” can refer to any change that results in a smaller amount of a symptom, disease, composition, condition, or activity. A substance is also understood to decrease the genetic output of a gene when the genetic output of the gene product with the substance is less relative to the output of the gene product without the substance. Also, for example, a decrease can be a change in the symptoms of a disorder such that the symptoms are less than previously observed. A decrease can be any individual, median, or average decrease in a condition, symptom, activity, composition in a statistically significant amount. Thus, the decrease can be a 1, 2, 3, 4, 5, 6, 7, 8, 9, 10, 15, 20, 25, 30, 35, 40, 45, 50, 55, 60, 65, 70, 75, 80, 85, 90, 95, or 100% decrease so long as the decrease is statistically significant.

“Inhibit,” “inhibiting,” and “inhibition” mean to decrease an activity, response, condition, disease, or other biological parameter. This can include but is not limited to the complete ablation of the activity, response, condition, or disease. This may also include, for example, a 10% reduction in the activity, response, condition, or disease as compared to the native or control level. Thus, the reduction can be a 10, 20, 30, 40, 50, 60, 70, 80, 90, 100%, or any amount of reduction below, above, or in between the given ranges as compared to native or control levels.

By “reduce” or other forms of the word, such as “reducing” or “reduction,” means lowering of an event or characteristic (e.g., bacterial infestation). It is understood that this is typically in relation to some standard or expected value, in other words it is relative, but that it is not always necessary for the standard or relative value to be referred to. For example, “reduces bacterial infestation” means reducing the rate of bacterial spread relative to a standard or a control.

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced. It is understood that where reduce or prevent are used, unless specifically indicated otherwise, the use of the other word is also expressly disclosed.

The term “effective amount” refers to the amount of the composition used is of sufficient quantity to ameliorate one or more causes or symptoms of a disease or disorder. Such amelioration only requires a reduction or alteration, not necessarily elimination.

“Composition” refers to any agent that has a beneficial biological effect. Beneficial biological effects include both therapeutic effects, e.g., treatment of a disorder or other undesirable physiological condition, and prophylactic effects, e.g., prevention of a disorder or other undesirable physiological condition (e.g., Leaf Spot Disease). The terms also encompass pharmaceutically acceptable, pharmacologically active derivatives of beneficial agents specifically mentioned herein, including, but not limited to, a vector, polynucleotide, cells, salts, esters, amides, proagents, active metabolites, isomers, fragments, analogs, and the like. When the term “composition” is used, then, or when a particular composition is specifically identified, it is to be understood that the term includes the composition per se as well as pharmaceutically acceptable, pharmacologically active vector, polynucleotide, salts, esters, amides, proagents, conjugates, active metabolites, isomers, fragments, analogs, etc. In some aspects, the composition disclosed herein comprises at least one compound of any aspect.

“Inhibitors” or “antagonist” of expression or of activity are used to refer to inhibitory molecules, respectively, identified using in vitro and in vivo assays for growth or activity of a described target organism or microbe, such as a bacterium. Inhibitors are agents that, e.g., bind to, partially or totally block growth or activity, decrease, prevent, delay activation, inactivate, desensitize, or down regulate, or permeate in a cellular membrane of the described target microbe or bacterium, e.g., antagonists. Control samples (untreated with inhibitors) are assigned a relative activity value of 100%. Inhibition of a described target microbe or bacterium is achieved when the activity value relative to the control is about 80%, optionally 50% or 25, 10%, 5%, or 1% or less.

The term “administer”, “administering”, or derivatives thereof refer to delivering a composition, substance, inhibitor, or compound to a subject or object by one or more the following routes: spraying, dripping, depositing, injecting, or other means of providing a composition, substance, inhibitor, or compound to a subject, such as a plant, tree, shrub, flower, or vegetable.

As used herein, the term “chemical compound” and “compound”, refers to a chemical substance consisting of two or more different types of atoms or chemical elements in a fixed stoichiometric proportion. These compounds have a unique and defined chemical structure held together in a defined spatial arrangement by chemical bonds.

As used herein, a “subject” means an individual organism. Thus, the “subject” can include plants or animals. Specifically, a subject that is a plant can include a vegetable, fruit, flower, grass, tree, shrub, fern, vine, or herb.

The terms “treat,” “treating,” “treatment,” and grammatical variations thereof as used herein, include partially or completely delaying, alleviating, mitigating, or reducing the intensity of one or more attendant symptoms of a disorder or condition and/or alleviating, mitigating or impeding one or more causes of a disorder or condition. Treatments according to the disclosure may be applied preventively, prophylactically, palliatively, or remedially.

A “bacterial infection” refers to when a bacterium or bacteria enter the body of an organism, such as a plant, increases in number, and causes a negative reaction within the body. In some embodiments, bacteria can enter a seed, seedling, young or developing plant, or an adult plant to cause infection.

### Methods of Treating or Preventing a Bacterial Infection

The present disclosure provides compounds and methods to treat or prevent a bacterial infection in a plant, for example, for treatment and prevention of leaf spot disease.

In one aspect, disclosed herein is a method of treating or preventing a bacterial infection in a plant, the method comprising administering to the plant an effective amount of at least one compound selected from the following:

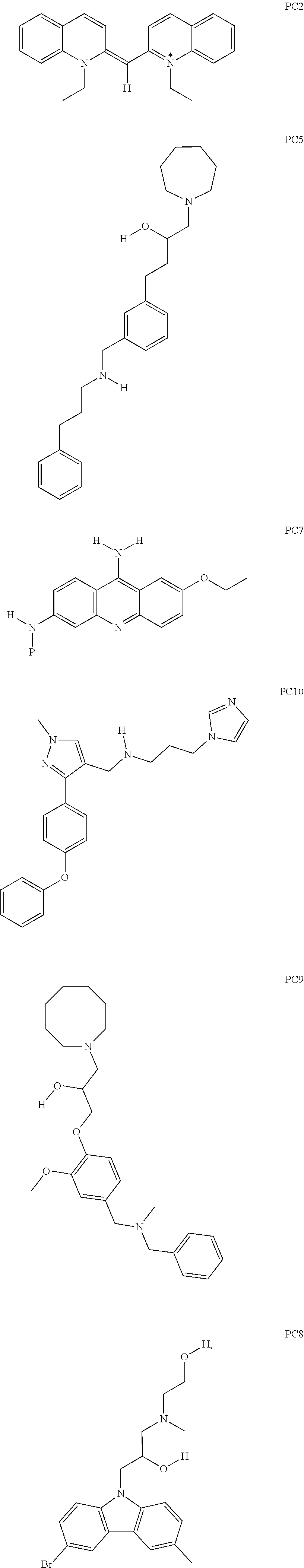

or a derivative thereof.

In some embodiments, the compound comprises PC2. In some embodiments, the compound comprises PC5. In some embodiments, the compound comprises PC7. In some embodiments, the compound comprises PC8. In some embodiments, the compound comprises PC9. In some embodiments, the compound comprises PC10.

In some embodiments, the compound is administered alone. In some embodiments, two or more compounds are administered in combination.

It should be understood that herein a leaf spot disease is a type of plant disease caused by a bacterial pathogen, wherein a spot or multiple spots appear on a leaf of an infested plant. The leaf spots are limited in size and discolored on the diseased plants. Common bacterial pathogen causing leaf spot diseases include but are not limited to Pseudomonas-related bacteria and Xanthomonas-related bacteria.

In some embodiments, the bacterial infection comprises a bacterial pathogen infesting a seed, a seedling, or a developing plant. In some embodiments, the bacterial infection causes a leaf spot disease. In some embodiments, bacterial infection causes a Pseudomonas leaf spot disease or a Xanthomonas leaf spot disease. As used herein, “infesting” refers to a process in which a pathogen or harmful substance spreads, takes over, or overwhelms a host organism, such as for example a seed, seedling, or a plant.

In some embodiments, the bacterial pathogen is selected from the group consisting of strains or pathovars of Agrobacterium tumefaciens, Erwinia amylovora, Erwinia tracheiphila, Pseudomonas syringae pathovars, Pantoea stewartia, Pectobacterium carotovorum, Serratia marcescens, Xanthomonas campestris pathovars, Xanthomonas cucurbitae, Clavibacter michiganensis and Xanthomonas euvesicatoria. In some embodiments, the bacterial pathogen comprises Pseudomonas syringae pv. syringae (Pss).

In some embodiments, the seed, seedling, or developing plant are selected from the group consisting of Solanaceae, Leguminosae, Cucurbitaceae, Rutaceae, Umbellifers, Brassicaceae, and Rosaceae.

In some embodiments, the seed, seedling, or developing plant is a vegetable.

In some embodiments, the seed, seedling, or developing plant is from the Solanaceae family. In some embodiments, the seed, seedling, or developing plant is a tomato. In some embodiments, the seed, seedling, or developing plant is a pepper. In some embodiments, the seed, seedling, or developing plant is a potato. In some embodiments, the seed, seedling, or developing plant is an eggplant. In some embodiments, the seed, seedling, or developing plant is a flower.

In some embodiments, the seed, seedling, or developing plant is from the Leguminosae family. In some embodiments, the seed, seedling, or developing plant a legume. In some embodiments, the seed, seedling, or developing plant is a pea. In some embodiments, the seed, seedling, or developing plant is a bean.

In some embodiments, the seed, seedling, or developing plant is from the Rutaceae family. In some embodiments, the seed, seedling, or developing plant is a citrus plant. In some embodiments, the seed, seedling, or developing plant is an orange. In some embodiments, the seed, seedling, or developing plant is a lemon. In some embodiments, the seed, seedling, or developing plant is a lime. In some embodiments, the seed, seedling, or developing plant is a grapefruit.

In some embodiments, the seed, seedling, or developing plant is from the Rosaceae family. In some embodiments, the seed, seedling, or developing plant is a fruit. In some embodiments, the seed, seedling, or developing plant is a berry. In some embodiments, the seed, seedling, or developing plant is tree. In some embodiments, the seed, seedling, or developing plant is a tree. In some embodiments, the seed, seedling, or developing plant a shrub.

In some embodiments, the compound is administered in combination with a beneficial bacterium. In some embodiments, the beneficial bacterium is selected from group consisting of Pseudomonas chlororaphis, Pseudomonas fluorescens, and Pseudomonas protegens.

In some embodiments, the plant is a vegetable, fruit, flower, tree, shrub, grass, or grain. In some embodiments, the plant is a pepper. In some embodiments, the plant is a tomato.

The present disclosure also provides methods of using inhibitors to treat or prevent a leaf spot disease in a plant.

### Methods of Treating or Preventing a Leaf Spot Disease

In one aspect, disclosed herein is a method of treating or preventing a leaf spot disease in a plant, the method comprising administering to the plant an effective amount of at least one compound selected from the following:

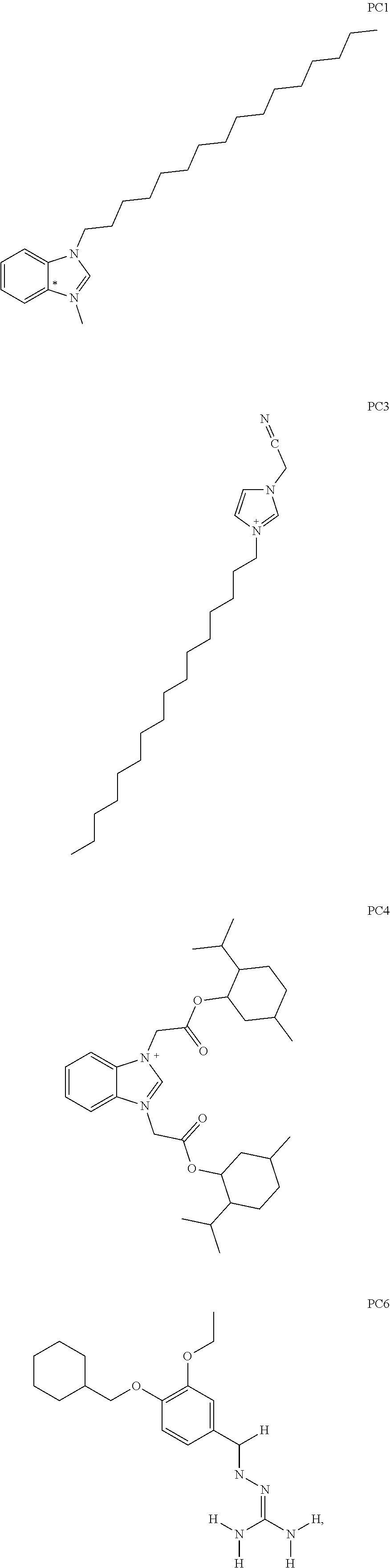

or a derivative thereof, wherein the leaf spot disease is a Pseudomonas leaf spot disease or a Xanthomonas leaf spot disease.

In some embodiments, the compound comprises PC1. In some embodiments, the compound comprises PC3. In some embodiments, the compound comprises PC4. In some embodiments, the compound comprises PC6.

In some embodiments, the compound is administered alone. In some embodiments, two or more compounds of any preceding aspect are administered in combination.

In some embodiments, the leaf spot disease comprises a bacterial pathogen infesting a seed, a seedling, or a developing plant.

In some embodiments, the bacterial pathogen comprises Pseudomonas syringae pv. syringae (Pss). In some embodiments, the seed, seedling, or developing plant are selected from the group consisting of Solanaceae, Leguminosae, Rutaceae, and Rosaceae.

In some embodiments, the seed, seedling, or developing plant is from the Solanaceae family. In some embodiments, the seed, seedling, or developing plant is a tomato. In some embodiments, the seed, seedling, or developing plant is a pepper. In some embodiments, the seed, seedling, or developing plant is a potato. In some embodiments, the seed, seedling, or developing plant is an eggplant. In some embodiments, the seed, seedling, or developing plant is a flower.

In some embodiments, the seed, seedling, or developing plant is from the Leguminosae family. In some embodiments, the seed, seedling, or developing plant a legume. In some embodiments, the seed, seedling, or developing plant is a pea. In some embodiments, the seed, seedling, or developing plant is a bean.

In some embodiments, the seed, seedling, or developing plant is from the Rutaceae family. In some embodiments, the seed, seedling, or developing plant is a citrus plant. In some embodiments, the seed, seedling, or developing plant is an orange. In some embodiments, the seed, seedling, or developing plant is a lemon. In some embodiments, the seed, seedling, or developing plant is a lime. In some embodiments, the seed, seedling, or developing plant is a grapefruit.

In some embodiments, the seed, seedling, or developing plant is from the Rosaceae family. In some embodiments, the seed, seedling, or developing plant is a fruit. In some embodiments, the seed, seedling, or developing plant is a berry. In some embodiments, the seed, seedling, or developing plant is tree. In some embodiments, the seed, seedling, or developing plant is a tree. In some embodiments, the seed, seedling, or developing plant a shrub.

In some embodiments, the compound is administered in combination with a beneficial bacterium. In some embodiments, the beneficial bacteria is selected from the group consisting of Pseudomonas chlororaphis, Pseudomonas fluorescens, and Pseudomonas protegens.

In some embodiments, the plant is a vegetable, fruit, flower, tree, shrub, grass, or grain. In some embodiments, the plant is a pepper. In some embodiments, the plant is a tomato.

### Methods of Administering Compounds

In one aspect, disclosed herein is a method of treating or preventing a bacterial infection causing leaf spot disease in a plant, the method comprising administering an inhibitor of leaf spot disease at 200 μM or lower concentrations.

In some embodiments, the inhibitor of leaf spot disease is administered at 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200 μM.

In some embodiments, the inhibitor of leaf spot disease is administered 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or more times. In some embodiments, the inhibitor of leaf spot disease is administered daily. In some embodiments, the inhibitor of leaf spot disease is administered every day, every 2 days, every 3 days, every 4 days, every 5 days, every 6 days, every 7 days, or more. In some embodiments, the inhibitor of leaf spot disease is administered every week, every 2 weeks, every 3 weeks, every 4 weeks, or more. In some embodiments, the inhibitor of leaf spot disease is administered every month, every 2 months, every 3 months, every 4 months, every 5 months, every 6 months, every 7 months, every 8 months, every 9 months, every 10 months, every 11 months, every 12 months, or more. In some embodiments, the inhibitor of leaf spot disease is administered every year, every 2 years, every 3 years, every 4 years, every 5 years, or more.

The inhibitor may be administered by any route deemed necessary in order to achieve the desired result. In some embodiments, the inhibitor of leaf spot disease is administered by spraying, dripping, depositing, injecting, or other means of administering the inhibitor.

The inhibitor may be administered in such amounts, time, and route deemed necessary in order to achieve the desired result. The exact amount of the inhibitor will vary from plant to plant.

In one aspect, disclosed herein is an inhibitor of any preceding aspect and a pharmaceutically acceptable carrier selected from an excipient, a diluent, a salt, a buffer, a stabilizer, a lipid, an emulsion, a nanoparticle, and a cream. One or more active agents (e.g. the compounds of any preceding aspect) can be administered in the “native” form or, if desired in the form of salts, esters, amides, prodrugs, or a derivative that is pharmacologically suitable. Salts, esters, amides, prodrugs, and other derivatives of the active agents can be prepared using standards procedures known to those skilled in the art of synthetic organic chemistry and described, for example, by March (1992) Advanced Organic Chemistry; Reactions, Mechanisms, and Structure, 4th Ed. N.Y. Wiley-Interscience.

### EXAMPLES

The following examples are set forth below to illustrate the compositions, devices, methods, and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

### Example 1. Novel Small Molecule Growth Inhibitors to Manage Pseudomonas Leaf Spot Disease on Peppers (Capsicum sp.)

This example identifies the SM growth inhibitors of Pss, assesses their safety, and evaluates their efficacy on Pss-infected pepper seeds and seedlings. Using high throughput screening 10 SMs (PC1 to PC10) were identified that inhibited the growth of Pss strains at 200 μM or lower concentrations. These SMs were effective against both copper- and streptomycin-resistant as well as biofilm-embedded Pss. These SMs were effective against other plant pathogens (n=22) at low concentrations (<200 μM) and had no impact on beneficial phytobacteria (n=12). Furthermore, these SMs showed better or equivalent antimicrobial activity against Pss in infested pepper seeds and inoculated seedlings, compared to copper-sulfate (200 μM) and streptomycin (200 μg/ml). Additionally, none of the SMs were toxic to pepper tissues (seeds, seedlings, or fruits), human Caco-2 cells, and pollinator honeybees at 200 μM. Overall, the SMs identified are alternative antimicrobials for managing PLS in pepper production.

Pseudomonas syringae pathovars are common phytopathogens that causes disease in almost all economically important crops, resulting in significant economic losses annually. In fact, in the last decade, there have been 72 outbreaks due to various pathovars of P. syringae in 40 different plant species across 20 countries. Pseudomonas syringae pv. syringae (Pss) is an emerging pathovar of P. syringae that is notorious for causing diseases in a wide range of plant hosts (Solanaceae [e.g., bell and chili peppers], Leguminosae [e.g., green beans], and citrus and stone fruit trees). Peppers are important annual crops used for fresh market consumption and processed products. In 2020, 4.7 million pounds of peppers were produced in the U.S., valued at $579 million. Pss is the causal agent of Pseudomonas leaf spot (PLS) in peppers, an endemic seedborne disease threatening the pepper production industry. Pss populations thrive when the humidity is high (>80%) and the temperature is moderate (20-24° C.). Once on plants and when environmental conditions are suitable, Pss uses a repertoire of virulence mechanisms to infect leaves. Pss causes circular necrotic spots on the leaves, which lead to premature senescence of the foliage over time. Thus, PLS causes a significant reduction in yield and quality of crops due to the rapid colonization and dissemination of Pss throughout the field. Pss can survive for an extended period on leaf surfaces as well as seeds as they are excellent epiphytes. For example, a related pathovar, P. syringae pv. tomato (Pst) that causes bacterial speck on tomato survived on stored tomato seeds for up to 20 years. Further, rain, wind and overhead irrigation are key factors in the dissemination of Pss from infected plants to healthy plants. Therefore, agricultural practices to manage this endemic disease during the growing season are crucial.

Currently farmers rely heavily on the intensive application of copper hydroxide or copper sulfate to reduce PLS during the growing season. Due to the intensive use of copper-based antimicrobials in recent years, emergence of copper-resistant Pss strains is becoming a concern. Streptomycin sulfate products can be used on young pepper transplants in greenhouses only. However, as of 2021, several reports also indicated the emergence of streptomycin resistant Pss strains, making these products ineffective. Further, streptomycin is an antibiotic frequently used to treat human infections. The intensive use of antibiotics in plant agriculture is associated with the development of antimicrobial resistance (AMR) in foodborne human pathogens which is a serious public health threat.

Given the severity and lack of effective management of PLS, there is an urgent need to identify control methods effective in mitigating PLS in seeds and seedlings and reduce the use of antibiotics in plant agriculture. Small molecules (SMs) are antimicrobials effective against multi-drug resistant pathogenic bacteria where antibiotics have failed. SMs are organic non-peptide compounds with drug-like properties of natural or synthetic origin. SMs are considered good candidates for drug development because they have a low molecular weight (<500 Da) and increased bioavailability, which facilitates their absorption and diffusion through the bacterial cell membrane and enhances their antimicrobial activity compared to several antibiotics. Further, SMs have multiple modes of action, increasing antimicrobial efficacy against pathogens as well as decreasing the likelihood of acquiring resistance in the near future. Therefore, SM growth inhibitors of Pss were identified in vitro by using a pre-selected SM library (n=4,182) and high throughput screening technology. A total of 10 SMS (Pss Compounds (PC), PC1-PC10) were identified that significantly reduced disease incidence, Pss load, and symptom severity in planta (i.e., seeds and seedlings). The selected compounds were confirmed to be effective against diverse Pss isolates (n=10) including copper and streptomycin resistant isolates, biofilm-protected Pss and other phytopathogens in vitro while having minimal impact of plant beneficial phytobacteria. No spontaneous resistance of Pss to these compounds was detected. Further, these selected compounds were not toxic to pepper tissues (seeds, seedlings, and fruits), human Caco-2 cell lines or pollinator honeybees.

### Materials and Methods

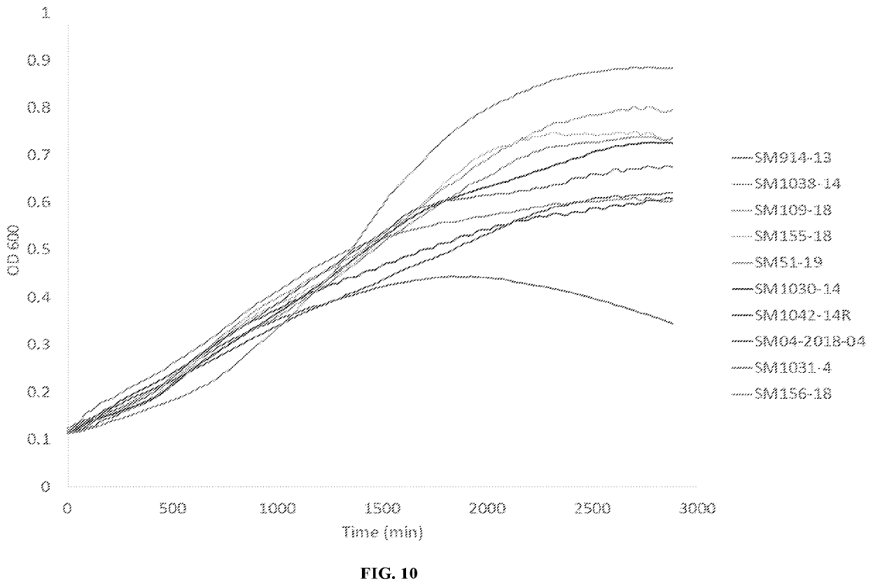

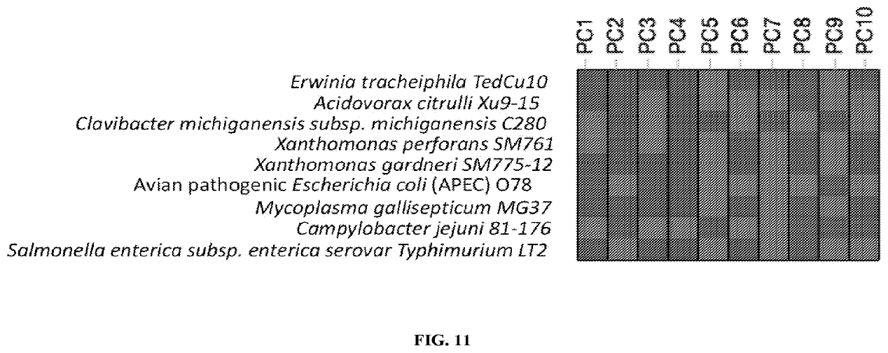

Bacterial strains. Ten Pss isolates were collected from different counties in Ohio from PLS symptomatic pepper plants between 2013-2019 (Table 2). Identity of the Pss isolates was confirmed using biochemical tests (LOPAT), molecular tests (PCR using syrB and hrpZ primers), and pathogenicity tests on pepper cultivars (unpublished data). Pss strains were grown in M9 minimal medium (33.7 mM Na₂HPO₄, 22 mM KH₂PO₄, 8.55 mM NaCl, 9.35 mM NH₄Cl, 1 mM MgSO₄ and 0.3 mM CaCl₂), supplemented with 0.8% glucose). Pseudomonas syringae pv. syringae strain SM1042-14R was used as a model strain for the assays conducted, unless indicated differently. The selection of the model strain was based on in vitro (i.e., growth rate, biofilm production and motility assay) and in planta (i.e., virulence on pepper seedlings) assays (Table 3; FIG. 10). The spectrum of activity of the selected SMs was tested on 10 diverse pepper Pss strains including those that are copper and streptomycin resistant, 12 plant beneficial bacteria and 22 plant pathogenic bacteria (Table 2). The beneficial and pathogenic bacteria were grown in half-strength Nutrient Broth Yeast extract (NBY) medium.

Plant material. Bell pepper (Capsicum annuum) cultivar ‘California Wonder’ seeds (Holmes Seed Company, Canton, OH, USA) and seedlings were used for the in-planta studies. ‘California Wonder’ seeds were produced organically and not coated. The seeds were sanitized using hot water and sodium hypochlorite treatment. In brief, seeds were subjected to a 10 min pre-soak in water at 37.8° C., then soaked for 25 min at 50° C., followed by agitation in a 20% Clorox (1.2% sodium hypochlorite) solution for 1 min, then a 5 min rinse in running tap water and air-drying. Sanitized seeds were sown individually in 96-cell plug trays containing Baccto Professional Grower Mix (Baccto, Houston, TX, USA) and grown in a greenhouse (25 to 28° C., 20-80% relative humidity, and 12 h photoperiod). The seedlings were grown until the four-true leaf stage (ca. 6-week-old) prior to testing the efficacy of the SMs against SM1042-14R. Plant experiments were conducted in a growth chamber with controlled temperature (24° C.), relative humidity (80%) and photoperiod (12 h). Seedlings were watered daily by hand. The toxicity of the SMs on pepper fruits was tested on fresh and organic ‘Sunset’ sweet bell peppers (green, red, and yellow pigmentation) obtained from a local market.

Small molecules (SM) library. A bioactive library consisting of 4,182 SMs was obtained in 96 well plate format from Chembridge, Inc. (San Diego, CA, USA). The SMs in the library weighed between 177.25 g/ml and 645.31 g/mol and had a partition coefficient (clogP) between 0.63 and 14.69. The SM were dissolved in 100% dimethyl sulfoxide (DMSO) at a final concentration of 100 mM and stored at −80° C.

Primary screening to identify growth inhibitors of Pss SM1042-14R using high-throughput screening. Primary screening of 4,182 SMs was conducted using a high throughput screening method to identify SMs that inhibited the growth of Pss SM1042-14R strain. A fresh bacterial culture of SM1042-14R was grown in M9 minimal broth in a shaking incubator (180 rpm) for 12 h at 28° C. The bacterial culture was normalized to a final optical density (OD₆₀₀) of 0.05 (c.a., 8.0×10⁷ CFU/ml) using a Genesys 20 spectrophotometer (Thermo Scientific, Rockford, IL, USA). In a sterile flat-bottom 96-well plate, 98 μl of the normalized bacterial suspension was challenged with 2 μl of SMs (final concentration of 200 μM). Controls were bacteria challenged with 2% DMSO (positive control; μc+), 50 μg/ml kanamycin (negative control; μc−), or M9 broth alone (blank control). The plate was incubated in a Sunrise Tecan kinetic microplate reader (Tecan Group Ltd., San Jose, CA, USA) for 48 h at 28° C. OD₆₀₀ was measured every 30 min.

The plate was agitated for 15 s at 180 rpm before reading the OD₆₀₀. Growth inhibition of SM1042-14R by the SMs was calculated using the following formula: % of inhibition=(μc+−X)/(μc+−μc−)×100, where μc+ and μc− is the average final OD₆₀₀ of the positive and negative controls, respectively, and X is the final OD₆₀₀ of each of the bacterial culture treated with a designated SM. After the 48 h of incubation with the SMs at 28° C., the viability of the bacterial culture was assessed by plating 5 μl of the culture on YDC (Yeast Dextrose Carbonate) agar medium, incubating the plate at 28° C. and monitoring any bacterial colonies on the plate after 48 h. The SMs completely inhibited the growth of SM1042-14R, but colonies grew on YDC agar medium were considered as bacteriostatic hits. The SMs that completely inhibited the growth of SM1042-14R, with no viable colonies detected on YDC agar medium were considered as bactericidal hits. The SMs showing antimicrobial activity against Pss were labeled as Pss Compounds (PC) hereafter.

Minimum inhibitory concentration (MIC) and minimum bactericidal concentration (MBC) of the 15 PCs against 10 Pss strains. A dose-response assay was conducted with the 15 PCs identified during the primary screening against 10 Pss strains including the model strain, SM1042-14R. The dose-response assay was conducted as described above with concentrations of PCs ranging from 3.125 to 500 μM. Pss treated with non-amended M9 minimal media, 2% DMSO, or 50 μg/ml kanamycin were used as controls. The plate was incubated in a Sunrise Tecan kinetic microplate reader for 48 h at 28° C. The percentage of inhibition and cell viability were determined as described above. The lowest concentration of PCs that only inhibited the bacterial growth was identified as the minimum inhibitory concentration (MIC). The lowest concentration of PCs that completely inhibited the growth and no viable colonies recovered was identified as the minimum bactericidal concentration (MBC).

Activity spectrum of the 15 PCs against plant pathogenic and plant beneficial bacteria. The antimicrobial specificity of the 15 PCs (bactericidal hits) identified in the primary screening was tested against 12 plant beneficial and 22 plant pathogenic bacteria. The plant beneficial and pathogenic bacteria were grown in 50% NBY overnight and OD₆₀₀ was adjusted to 0.05, as described previously. In a 96-well plate, bacterial cultures were challenged with 1×MBC (final concentration ranging from 12.5 μM to 200 μM) of PCs identified as being effective against Pss SM1042-14R. Bacterial strains treated with nutrient-limited broth (50% NBY) alone, 2% DMSO, or 50 μg/ml kanamycin were used as controls. The plate was incubated for 48 h at 28° C. in the Sunrise Tecan microplate reader, as described above. The percentage of inhibition and cell viability were determined as described above.

Effect of the ten selected PCs on biofilm-embedded Pss. The effect of the ten selected PCs was evaluated on biofilm-embedded SM1031-14 using the minimal biofilm eradication concentration (MBEC) high throughput assay (Innovotech, Edmonton, AB, Canada). Pss strain SM1031-14 was chosen for this assay because it was the highest biofilm producer among the ten Pss strains tested (Table 3). SM1031-14 was grown overnight in M9 minimal medium in a shaking incubator (180 rpm) for 12 h at 28° C. The bacterial culture was normalized to 0.05 OD₆₀₀ (c.a., 1×10⁷ CFU/ml) in fresh M9 minimal broth. In a sterile, non-treated MBEC device containing polystyrene pegs, 150 μl of the adjusted bacterial culture was transferred. The MBEC plates were sealed using parafilm and incubated without shaking at 28° C. for 72 h in M9 broth to allow biofilm formation on the polystyrene pegs. After biofilm formation, the pegs were washed with sterile water to remove planktonic cells adhered to the pegs. For the treatment of the biofilm using PCs, the pegs were transferred to a new 96-well plate, and challenged with 0.5×, 1×, 2×, and 4×MBC of each of the ten selected PCs in 200 μl of M9 broth. Plates were incubated for 24 h at 28° C. in the dark with shaking at 110 rpm. The PCs-exposed pegs were then transferred to new 96-well plates containing 1×PBS and sonicated for 60 min at room temperature with an Aquasonic ultrasonic cleaner (VWR, Radnor, Pam USA) to disrupt the biofilm. The product of the sonication was serially 10-fold diluted and plated on YDC agar to determine the MBEC of PCs. The lowest concentration at which there were no viable colonies present when plated on YDC agar medium was considered as MBEC for each of the PCs. Concurrently, a dose response assay with planktonic SM1031-14 was conducted as described above for comparison of the PCs bactericidal activity with the biofilm protected bacteria. Pss SM1031-14 treated with non-amended M9 minimal medium and 2% DMSO were used as controls. The experiment was performed twice, with three biological replicates for each treatment.

Antimicrobial resistance studies. To determine the potential of SM1042-14R to acquire resistance to the selected ten PCs, antimicrobial resistance studies were performed via single step (lethal dose) and sequential passage (sublethal dose) methods. For the single-step resistance, M9 agar medium amended with 2×MBC of PCs was prepared in a sterile 24-well plate. An overnight culture of SM1042-14R was normalized to OD₆₀₀ of 1.0 (approximately 10⁹ CFU/well). In each of the wells containing different PCs, 50 μl of the adjusted bacterial culture was plated onto the 24 well agar plate. The plate was sealed using parafilm and incubated in the dark at 28° C. for 15 days. After 15 days, any colonies that grew on the 24-well plate were evaluated for MIC and MBC as described above. The experiment was conducted with three replicates per treatment group. SM1042-14R plated on non-amended M9 agar medium, 2% DMSO or 50 μg/ml kanamycin were used as controls.

For sequential passage (sublethal dose) resistance assay, SM1042-14R was grown in M9 minimal broth and adjusted to OD₆₀₀ of 0.05 (approximately 10⁷ CFU/ml). In a 96-well plate, 98 μl of the adjusted bacterial culture was transferred and 0.75×MBC of PC (concentration that allows approximately 70% growth inhibition) was added into the wells. Plates were incubated at 28° C. with 150 rpm shaking for 24 h in the dark. After incubation, cells were centrifuged, the pellet was resuspended in fresh M9 broth amended with 0.75×MBC of PC and grown as described above. This procedure was repeated 14 times. After 15 passages, MIC, and MBC of the PCs to SM1042-14R were determined as described above. This was conducted with three replicates per treatment group. SM1042-14R grown in non-amended M9 broth, 2% DMSO or 50 μg/ml of kanamycin were used as controls for each passage.

Phytotoxicity of the ten selected PCs on pepper tissues. The toxicity of the PCs to plant tissues was assessed on pepper seeds, seedlings, and fruits. As controls, seeds, seedlings, and fruits were treated with 1.2% thymol, 1% 2,4-D herbicide, or 2% DMSO.

Toxicity on seeds. In 2 ml sterile glass vials, 1.5 ml of 1% molten water agar was prepared and supplemented with 200 μM of PCs. Four seeds (‘California Wonder’) were sown into the vials. The vials were incubated in the dark at room temperature for 12 days until the seeds germinated. After incubation, seed germination percentage, germling root and shoot length, and necrotic and chlorotic symptoms were recorded from eight treated seeds per treatment group. This was performed twice.

Toxicity on seedlings. ‘California Wonder’ pepper seeds were sown in sterile 2 ml glass vials containing 1.5 ml of 1% molten water agar. Four seeds were sown in each vial and incubated for 14 days in the dark at room temperature for the seedlings to sprout. Fifty microliters of PCs (200 μM final concentration) were deposited onto the cotyledons of the seedlings and incubated for another 7 days. After 7 days, necrotic and chlorotic symptoms were assessed for 16 treated seedlings per treatment group. This was performed twice.

Toxicity on bell pepper fruits. Pepper fruits were thoroughly washed in soapy water and dried prior to PC treatment. On the surface of each fruit Sul of the PCs (200 μM final concentration) were deposited and air dried under a laminar hood for 30 min. The fruits were incubated in the dark at room temperature and monitored daily for necrotic and chlorotic symptoms. This was performed twice.

Toxicity of the ten PCs on pollinator honeybees. To determine whether the ten selected PCs were toxic to honeybees, an acute topical bioassay was used as recommended by the Ecological Effects Test Guidelines (OCSPP 8503020: Honeybee Acute Contact Toxicity Test). Frames of late stage capped brood were collected from two healthy colonies headed by New Carniolan queens maintained at The Ohio State University Wooster Campus. New adult bees were allowed to emerge in a dark incubator maintained at 32° C. and 60-80% relative humidity and brushed into bulk storage cages daily. Bees were fed sucrose in water (1:1 w/w) and aged for three days in the incubator. Cages of 3-day-old honeybees were anesthetized using carbon dioxide for 2 min and separated into groups of 20 housed in paper cups (UNIQ 6 oz Cups; Frozen Dessert Supplies, Rexburg, Idaho, USA) covered with #20 cotton cheesecloth. The ten PCs were prepared at 200 μM concentration in DMSO. Small groups of honeybees were anaesthetized again with 30 s of carbon dioxide before topical application. The honeybees were individually treated by topically applying lul of the PCs on the dorsal side of thorax using a micro applicator (Hamilton PB-600, Reno, Nevada, USA). Cages of bees were returned to the incubator with a punctured 1.5 ml microcentrifuge tube filled with sucrose water was inserted into the cheesecloth, refreshed daily, to feed the bees. The mortality of the bees was recorded daily for 48 h. Honeybees treated with DMSO, or thiamethoxam (insecticide, 0.35 μg of active ingredient per bee) were used as controls. This was performed twice.

Cytotoxicity of the ten PCs to human cells. The cytotoxicity of the ten selected PCs was tested on Caco-2 (human colonic carcinoma, ATCC HTB-37) cells. Caco-2 cells were grown in minimal essential medium (MEM) supplemented with 1% nonessential amino acid, 1 mM sodium pyruvate and 20% fetal bovine serum. Freshly grown cells were seeded in sterile non-treated 96-cell culture plates at 1.4×10⁵ cells per well. The cells were incubated at 37° C. and 5% CO₂ for 48 h until a complete monolayer was formed. The cells were washed gently using incomplete MEM (MEM without fetal bovine serum and antibiotic) twice. After washing, 150 μl of incomplete MEM was added, amended with PCs at 200 μM concentration. The cells were incubated with the PCs for 24 h after which a colorimetric CyQUANT™ LDH Cytotoxicity Assay (ThermoFisher Scientific, Waltham, MA, USA) was used to measure the cytotoxicity of the PCs, following the manufacturer's instructions. Fifty microliters of the supernatant from the wells containing cells treated with the PCs were transferred onto a new sterile 96-well plate. A reaction mixture from the assay kit was added to the 96-well plate, which resulted in changing the color of the wells depending on the level of LDH released from the cells. LDH is an enzyme that is released by damaged cells indicating cytotoxicity of the treatment. The color change was measured at OD 680 nm and 490 nm using a microplate reader (EMax® Endpoint ELISA Absorbance Microplate Reader, Radnor, PA, USA). Each treatment group had three replicates and the experiment was conducted twice. Caco-2 cells treated with incomplete MEM media, 10× Lysis buffer or 2% DMSO were used as controls. This was performed twice.

Antimicrobial efficacy of the ten PCs on Pss SM1042-14R-inoculated pepper seedlings. Six-week-old pepper seedlings (four-true leaf stage) were inoculated by spraying the foliage (5 cm away from the plant at a 45 angle) with Pss SM1042-14R (1 ml per seedling, 1.0 OD₆₀₀=approximately 1×10⁹ CFU per plant) with a commercial hand sprayer (Equate 8 oz plastic spray bottle, TX, USA). The Pss SM1042-14R inoculum was prepared as described above in M9 minimal medium at 28° C. and shaken at 180 rpm overnight. Inoculated seedlings were incubated in a growth chamber (28° C., 20 to 80% relative humidity, 12 h photoperiod). Infected seedlings were either treated with 200 μM of PCs one day prior to inoculation (preventative method) or one day post inoculation (curative method). Ten seedlings were sprayed with the PCs, approximately 250 μl/seedling, per treatment group. Similarly, ten seedlings sprayed with 2% DMSO, copper sulfate (200 μg/ml, Sigma Aldrich, St. Louis, MO, USA), or streptomycin (200 μM, Sigma Aldrich) were used as controls. Disease severity (number of lesions on the surface of two lower leaves for each seedling) and incidence (number of seedlings showing PLS symptoms) were recorded 7 days post inoculation (dpi). The bacterial population was determined by direct dilution plating as follows. Seedlings (1 cm above the soil) were cut using sterile scissors and collected individually in Whirl-Pak bags. The weight of each seedling was measured prior to adding 2 ml of 1×PBS. The seedlings were macerated, and the macerate was serially diluted and plated on a semi-selective NBY agar medium supplemented with copper sulfate (25 μg/ml). NBY plates supplemented with copper sulfate were used because all Pss strains used in this study were resistant to at least 25 μg/ml of copper sulfate. Plates were incubated at 28° C. for 48 h to determine the Pss SM1042-14R population per seedling by counting the colonies. This was performed twice with ten replicates per treatment.

Antimicrobial efficacy of ten selected PCs on pepper seeds artificially infested with Pss SM1042-14R. ‘California Wonder’ pepper seeds were used for artificial infestation with Pss SM1042-14R and PC treatment. Inoculum of Pss SM1042-14R was prepared by growing SM1042-14R in M9 minimal medium overnight as described above. The OD₆₀₀ was adjusted to 0.1; approximately 1×10⁸ CFU/ml. The adjusted inoculum (45 ml of inoculum for 4 g seeds) was transferred to a sterile glass beaker and placed in a Nucerite desiccator (Nalge Sybron, Milwaukee, WI, USA). Seeds were vacuum infiltrated with inoculum at 15 PSI for 5 min. Infested seeds were air-dried in a laminar flow hood at room temperature for 12 h. The dried seeds were transferred to 5 ml sterile tubes and soaked in 1 ml of PCs (200 μM) diluted in sterile water for 20 min. The seeds were air-dried again. Seed aliquots were collected at 1, 3-, 10-, 20-, and 30-days post infestation (dpi, 10 seeds per treatment group per time point). Bacterial populations were estimated by macerating five batches of two seeds per treatment group in 400 μl of 1×PBS in a Whirl Pak bag. The macerate was serially diluted and plated onto semi-selective NBY agar medium supplemented with copper sulfate (25 μg/ml). Seeds treated with 2% DMSO, copper sulfate (200 μg/ml), or streptomycin (200 μM) were used as controls. This was performed twice.

Structure-activity relationship (SAR) analysis and common functional groups. For the SAR analysis, physio-chemical properties (PCP) of the selected ten PCs were compared based on their performance in vitro and in planta. A total of 60 PCP were obtained from multiple reference databases (ChemBridge, PubChem Compounds, Joelib, ChemMine, and OpenBabel). The in vitro data (MIC/MBC against Pss strains, MBEC against biofilm protected Pss, spectrum of activity against plant beneficial and pathogenic bacteria), toxicity data (toxicity on pepper tissues, honeybees, and Caco-2 human cell lines), and in planta data (efficacy of PCs against Pss infected seeds and seedlings), were correlated to the 60 PCP of the ten PCs to identify PCP profiles that contribute the most to the antimicrobial activity of the PCs. A structural analysis of the ten PCs was also conducted based on Two-dimensional (2D) Tanimoto scoring to determine if structural similarity could explain antimicrobial activity of the PCs. The Tanimoto scores were calculated from 2D structure fingerprints using a single linkage algorithm. The chemical structures of the 10 PCs were extracted and common function groups between the PCs were identified using ChemBridge Hit2lead, PubChem Compounds (National Center for Biotechnology Information; Rockville Pike, MD, USA), and ChemMine website (https://chemminetools.ucr.edu/).

Statistical analyses. The groups within the growth chamber were randomized for each plant experiment. All statistical analyses of the experimental data were conducted using JMP Pro16 (SAS, Cary, NC). Bacterial load data were log-transformed, and toxicity (% of seed germination, % mortality of honeybees, and % cytotoxicity) and symptoms data recorded as percentage were arcsine-transformed before performing statistical analyses. Continuous datasets were tested for normality and variance using the Shapiro-Wilk test prior to performing a parametric one-way ANOVA combined with a Tukey test (P<0.01). Several tests were also conducted to test the equal variance between two trials conducted for each of the experiments. Five tests were conducted to test equal variance between trials, including O'Brien test, Brown-Forsythe test, Levene test, Bartlett test and two-sided F test (P<0.05). A parametric Dunnett's multiple comparison test was used to identify significant differences in bacterial load between the SM treated groups and the DMSO control group, and between the SM treated group and streptomycin and copper sulfate control groups (P<0.01). For the SAR analysis with the PCP, a bootstrap forest method followed by a multivariate correlation analysis was used to determine PCPs that significantly correlated with antimicrobial activity of the PCs (P<0.01).

### Results

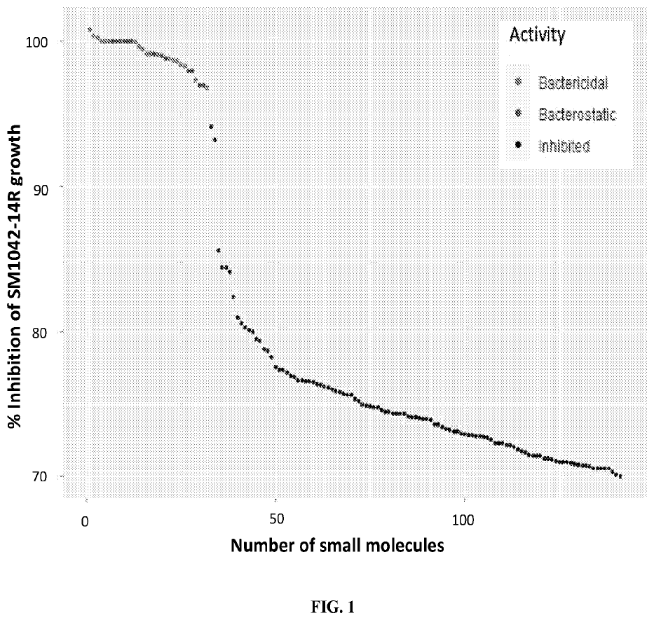

Fifteen PCs were bactericidal to Pss SM1042-14R. A model Pss strain SM1042-14R was used for the SM screening as it was the most virulent strain identified (disease incidence=100% and disease severity >17%) in planta (Table 3). A high throughput primary screening of 4,182 SM was conducted at 200 μM against Pss SM1042-14R strain in nutrient-limited conditions. A total of 141 PCs inhibited the growth of Pss SM1042-14R by at least 70%. Fifteen were bactericidal and 12 were bacteriostatic against Pss SM1042-14R at 200 μM (FIG. 1).

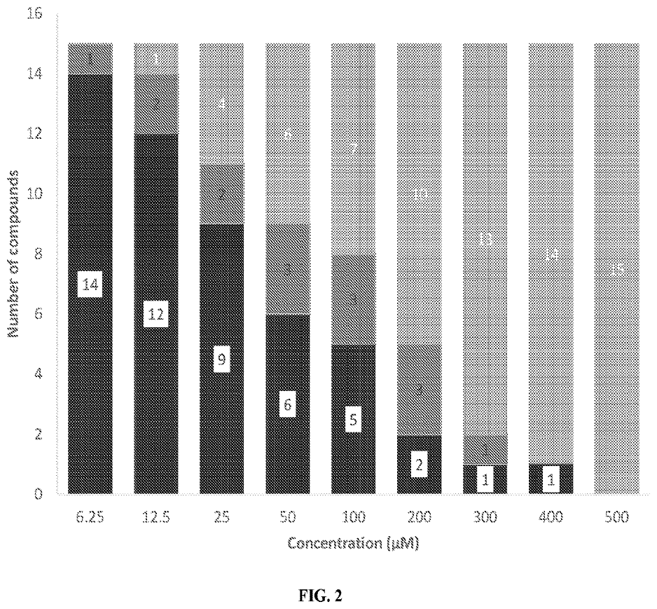

Selected PCs showed low MIC and MBC against ten Pss strains. The antimicrobial efficacy (MIC and MBC) of 15 selected PCs was tested against ten Pss strains collected from different geographical locations in Ohio, United States (Table 2). A range of concentrations from 6.25 μM to 500 μM was tested against the ten Pss strains in minimal nutrient conditions (M9 broth). Overall, the antimicrobial efficacy of the PCs was equivalent between the Pss strains (Table 4). The MIC and MBC of most of the PCs (n=10/15) ranged between 6.25 μM to 200 μM and 12.5 μM to 200 μM, respectively, against Pss SM1042-14R (FIG. 2) and across the different Pss strains (Table 4). Four PCs (PC7, PC8, PC9 and PC10) exhibited MICs and MBCs between 50 μM to 200 μM across the different Pss strains, two PCs (PC5 and PC6) possessed MICs and MBCs between 25 μM to 50 μM and four PCs possessed MICs and MBCs between 6.25 μM to 25 μM against most Pss strains (n=6/10, Table 4).

### Specificity of the 15 PCs Against Plant Pathogenic and Plant Beneficial Bacteria.

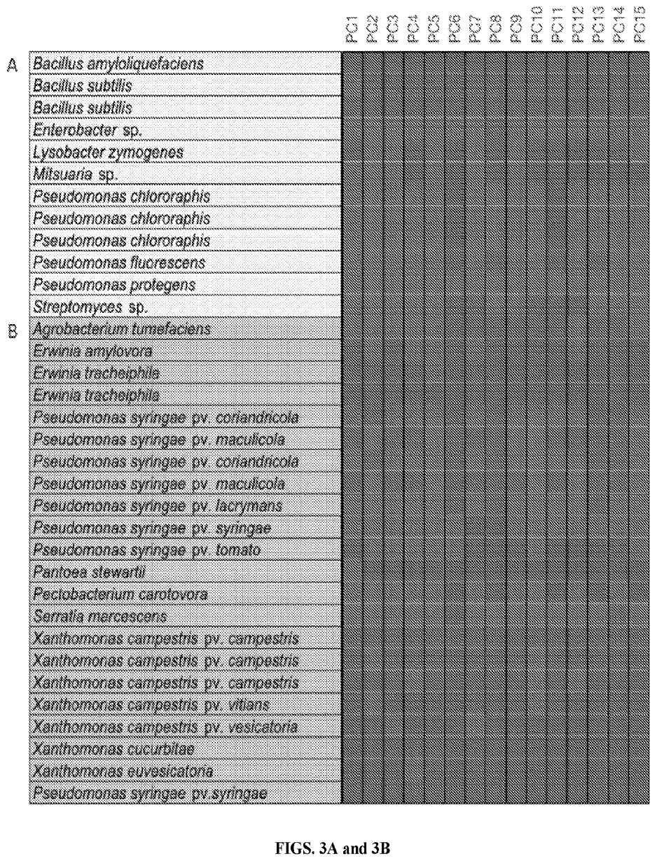

The activity spectrum of 15 PCs (bactericidal PCs identified from primary screening) was tested at 1×MBC against plant pathogenic (n=22) and plant beneficial bacteria (n=12) in nutrient limited conditions (50% NBY broth; FIG. 3). Overall, most of the PCs were bactericidal against Xanthomonas species (X. campestris pathovars campestris, vitians and vesicatoria, X. cucurbitae and X. euvesicatoria), Erwinia tracheiphila and Pantoea stewartii. However, only four PCs (PC6, PC8, PC13 and PC14) were bactericidal against pathogenic Pseudomonas species, including Pseudomonas syringae pathovars (FIG. 3B). The remaining PCs (n=11/15) had varying bactericidal effects against other pathogenic Pseudomonas species. On the other hand, most of the PCs (n=13/15; all but PC1 and PC11) were not bactericidal against plant beneficial bacteria, especially beneficial Pseudomonas species (P. chlororaphis, P. fluorescens and P. protegens; FIG. 3A). Similarly, most of the PCs (n=14/15, except for PC8) did not impact the growth of Enterobacter sp. Most of the PCs (n=10/15, except for PC6, PC7, PC10, PC11, and PC12) did not impact the growth of Streptomyces sp. However, growth of Bacillus species, Lysobacter zymogenes and Mitsuaria species was suppressed by most of the PCs (FIG. 3A). In addition, ten PCs were also effective, tested in our previous screens, against other plant (Acidovorax citrulli Xu22-15, Clavibacter michiganensis C290, Xanthomas hortorum pv. gardneri, X. euvesicatoria pv. perforans, and Erwinia tracheiphila TedCu10), animal (avian pathogenic Escherichia coli 078 and Mycoplasma gallisepticum) and foodborne human pathogens (Salmonella enterica subsp. enterica serotype Typhimurium JSG626 and Campylobacter jejuni 81-176) (FIG. 11). Based on the results obtained from the antimicrobial efficacy and activity spectrum assays, ten PCs (PC1, PC2, PC3, PC4, PC5, PC6, PC7, PC8, PC9, and PC10) with the highest antimicrobial efficacy (≤200 μM) against Pss SM1042-14R and with a narrow spectrum of activity against Pss were selected for further studies.

Ten PCs eradicated biofilm-embedded Pss SM1031-14R at the same concentration as planktonic bacteria. Overall, the antimicrobial efficacy of the PCs was not affected by the presence of biofilm. The ten PCs possessed Minimal Biofilm Eradication Concentrations (MBEC) of 1× to 4×MBC in the MBEC high throughput assay, which was the same as the MBC concentrations (1×MBC ranging between 12.5 μM to 200 μM). The same MBEC values (12.5 μM to 200 μM) were obtained for biofilm protected and planktonic Pss.

Pss SM1042-14R did not acquire resistance against the ten selected PCs. The potential for acquisition of resistance against the ten PCs was assessed by comparing the antimicrobial efficacy (MIC and MBC determination as described above) of the PCs against SM1042-14R. Overall, the SM1042-14R cultures or colonies recovered from the single passage and sequential passages resistance assays displayed similar or same sensitivity to the ten PCs compared to the original culture from glycerol stock. Thereby, SM1042-14R did not develop resistance against these ten PCs. On the other hand, SM1042-14R colonies insensitive to streptomycin (MBC>25 μg/ml versus MBC=12.5 μg/ml for original culture from glycerol stock) were isolated after the sequential passages' resistance assay.

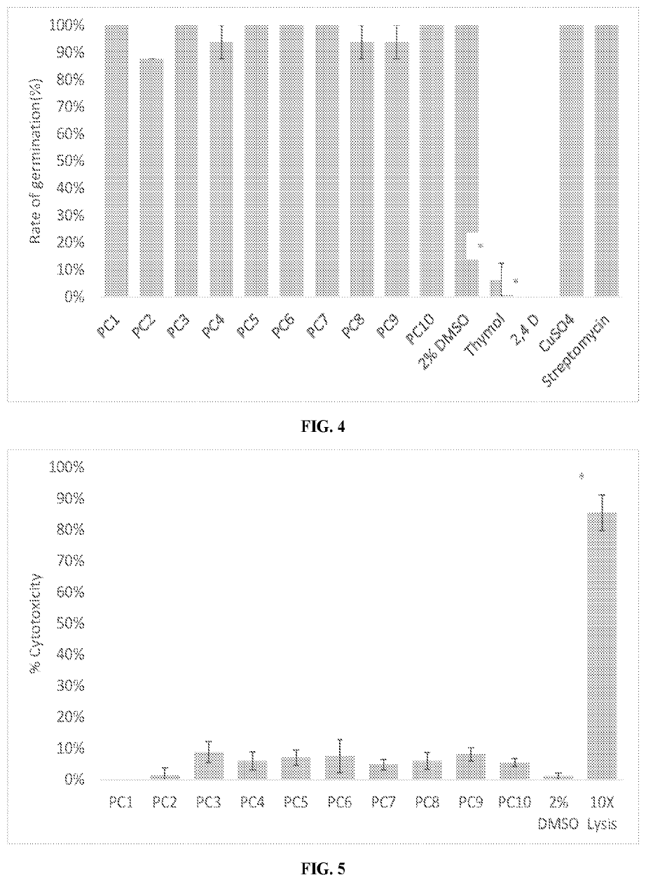

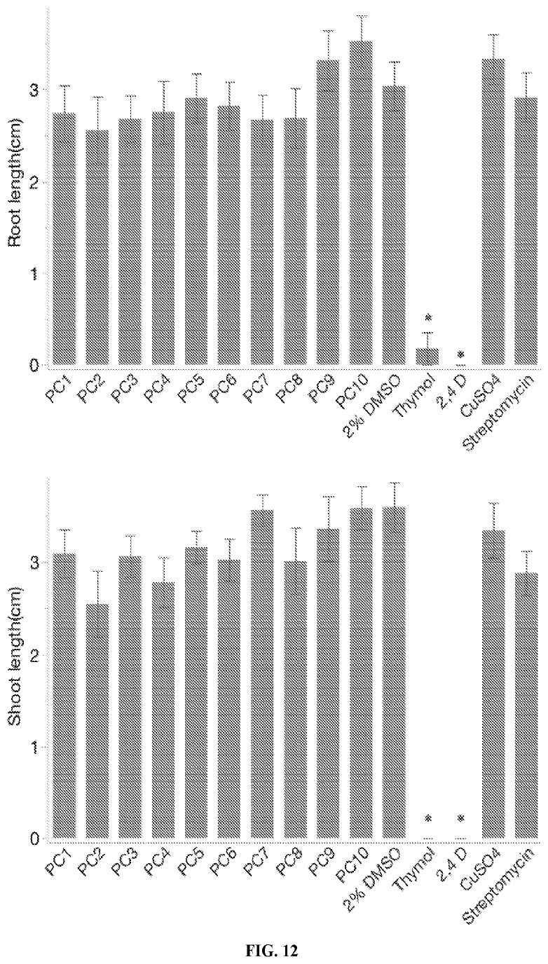

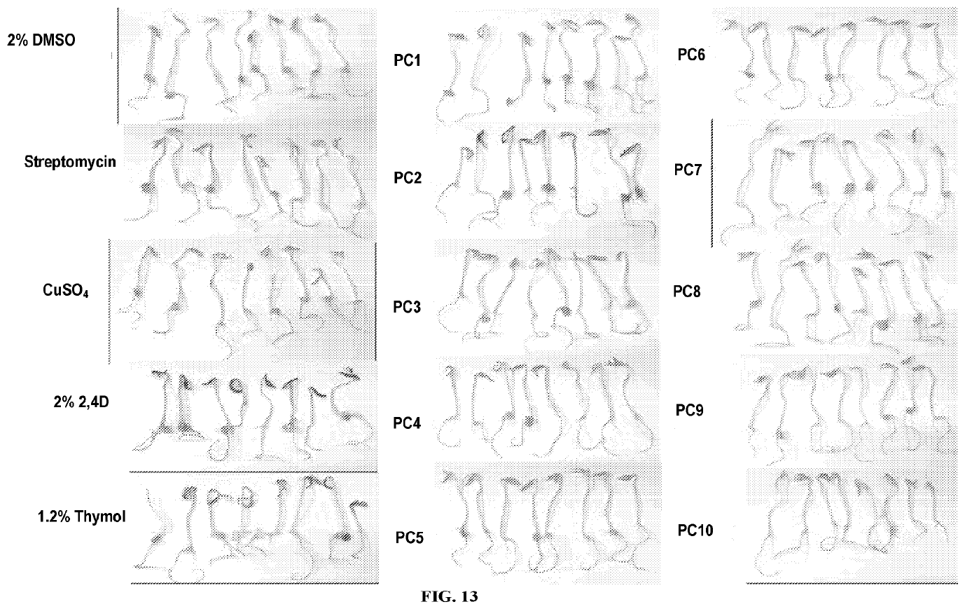

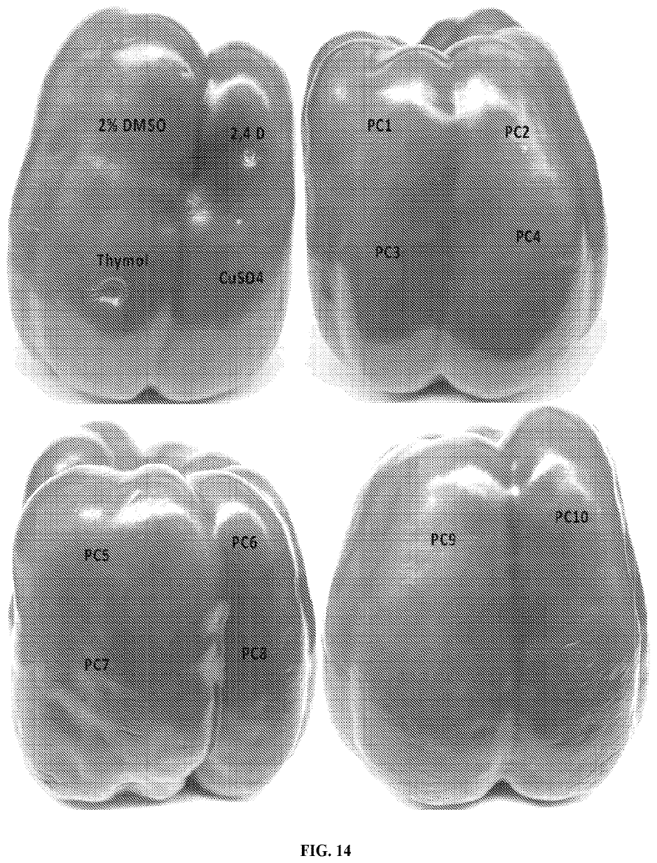

PCs had minimal toxicity on pepper tissues at 200 μM. None of the ten PCs affected the germination of pepper seeds (>80% gemination) assessed on day 14. On the other hand, the positive controls (thymol and 2,4 D) caused significant decreases in the rate of germination (ranging from 0% to 5% germination, FIG. 4; P<0.01) compared to DMSO-treated controls. Additionally, the PCs did not affect root (2.8±1.2 cm) or shoot (2.3±0.6 cm) length of germlings compared to the DMSO-treated controls (root: 3.0±1.0 cm and shoot: 2.2±0.7 cm), whereas the positive controls (thymol and 2,4 D) caused significant decreases in root (1.5±0.7 cm) and shoot (0 cm) length (FIG. 12). No necrotic or chlorotic symptoms were observed on two-week-old seedlings with the ten selected PCs (200 μM) at 7 days post application (DPA) (FIG. 13). However, thymol and 2,4-D herbicide caused severe necrotic and chlorotic symptoms compared to the 2% DMSO control group (FIG. 13). Likewise, no necrotic or chlorotic symptoms were detected on the surface of the organic pepper fruits treated with the PCs (FIG. 14). On the other hand, fruits treated with thymol, or 2,4-D herbicide showed severe necrotic and chlorotic symptoms on the surface (FIG. 14).

### PCs had Minimal Cytotoxicity on Caco-2 Human Cell Line and Honeybees at 200 μM.

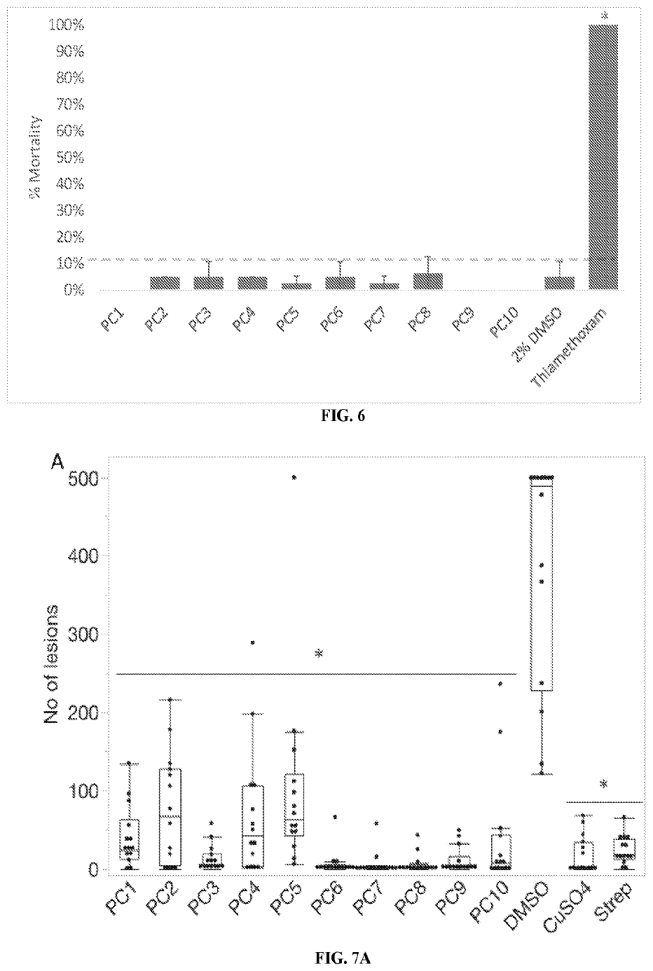

The toxicity of the ten selected PCs was tested on human Caco-2 cell lines at 200 μM. Overall, the ten PCs caused minimal cytotoxicity to the Caco-2 cells, less than 10% compared to the positive control (10× lysis buffer) that caused toxicity of 86% (FIG. 5). The honeybees treated topically with the PCs showed less than 10% mortality at 48 h (FIG. 6). The US Environmental Protection Agency (EPA) considers compounds causing less than 10% mortality of the honeybees to have minimal toxicity. Honeybees treated with the positive control (thiamethoxan) showed significantly higher mortality of 100% at 48 h (FIG. 6).

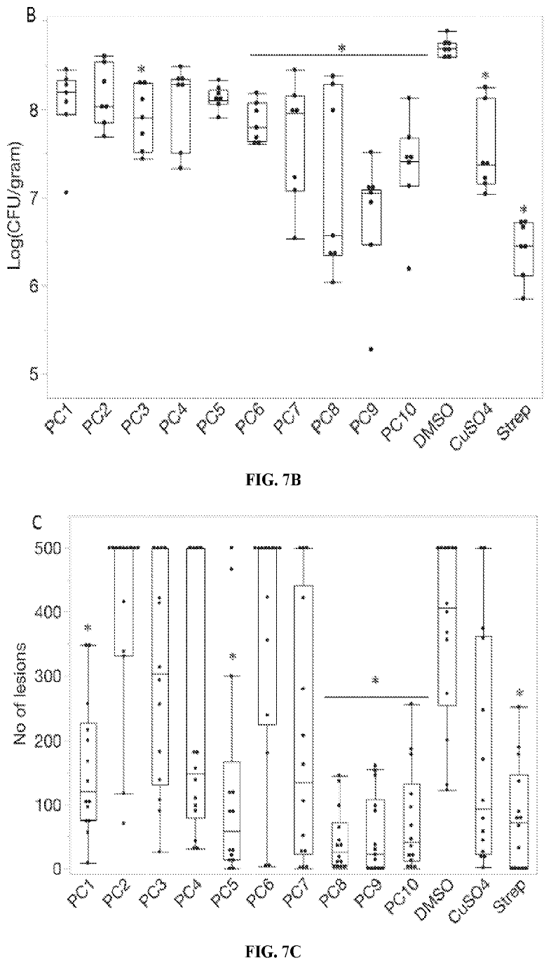

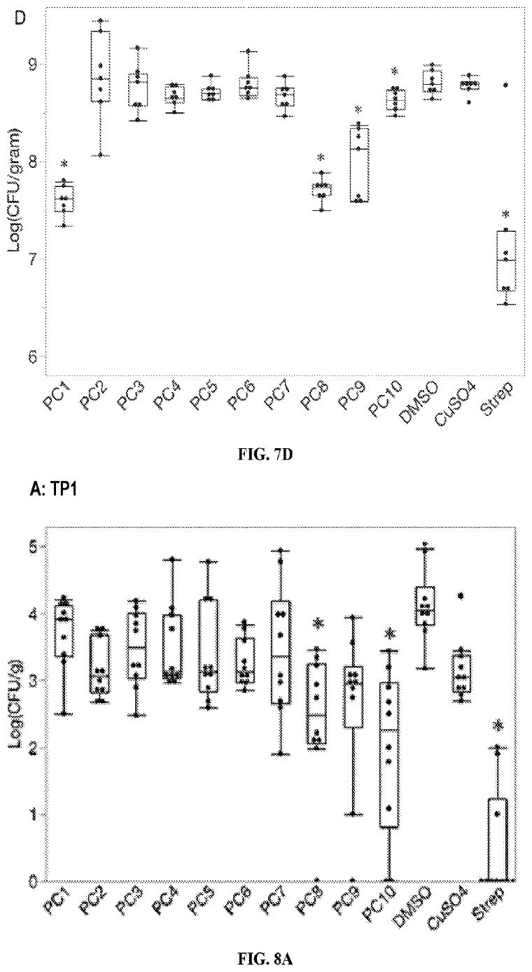

The ten selected PCs significantly reduced Pss load, disease incidence and/or severity in inoculated seedlings at 200 μM. Overall, a higher reduction in the bacterial load, reduced disease severity (number of symptomatic lesions on leaves), and decreased disease incidence (number of seedlings showing disease symptoms) were observed 7 days post inoculation (dpi) when a curative approach was used compared to the preventive approach. For curative applications, all PC treatments significantly reduced disease severity (between 26.3 and 48.6±18.8 lesions) at 7 dpi compared to the DMSO-treated groups (387.6±149.2 lesions; P<0.01; FIG. 7A). This reduction in disease severity was better than or equivalent to that observed after treatment with CuSO₄ and streptomycin (CuSO₄: 28.1±13.9, streptomycin: 24.4±18.2 lesions). The reduction in disease severity observed with PC3, PC6, PC7, PC8, PC9, and PC10 was associated with significant reductions in bacterial load in the infected seedlings at 7 dpi (P<0.01; FIG. 7B). The PC9-treated group displayed a 1.9±0.7 log CFU/g Pss reduction compared to the DMSO group (8.7±0.3 log CFU/g; P<0.01), statistically equivalent to the streptomycin-treated group (reduction of 2.2±0.5 log CFU/g compared to the DMSO group; P<0.01). Similarly, PC3, PC6, PC7, PC8, and PC10-treated groups exhibited a significant reduction in Pss load in inoculated seedlings (between 1.4±0.2 log CFU/g and 1.6±1.0 log CFU/g) compared to the DMSO group (8.7±0.1 log CFU/g; P<0.01), which is better than or equivalent to that of the CuSO₄-treated group (reduction of 1.1±0.5−log CFU/g compared to the DMSO-treated group; P<0.01).

Application of all PCs except PC4 and PC5 resulted in lower disease incidence (between 57% and 86%) at 7 dpi compared to the DMSO-treated groups (100%; P<0.01; Table 5). Disease incidence after application of some PCs (PC1, PC2, PC3, PC9, and PC10, between 57% to 86% incidence) was less than or equivalent to that of the streptomycin-treated group (86% disease incidence; P<0.01). The CuSO₄-treated group (57% disease incidence; P<0.01) showed lower disease severity than the streptomycin-treated group (86% disease incidence; P<0.01). Treatment of three PCs (PC6, PC7, and PC8) resulted in equivalent disease incidence to that of the CuSO₄-treated group.

For the preventative approach, five PCs (PC1, PC5, PC8, PC9, and PC10) significantly reduced disease severity (between 163.8 and 227.2±118.6 lesions) at 7 dpi compared to the DMSO-treated groups (375.9±141.8 lesions; P<0.01; FIG. 7C). This reduction in disease severity was better than or equivalent to that of the plants treated with CuSO₄ and streptomycin (CuSO₄: 188.4±163.5, streptomycin: 88.8±62.5 lesions). The reduction in disease severity observed with PC1, PC8, and PC9 was associated with significant reductions in bacterial load in the infected seedlings at 7 dpi (P<0.01; FIG. 7D). PC1-, PC8-, and PC9-treated groups displayed a significant reduction in Pss load in inoculated leaf tissues (between 0.8±0.4 log CFU/g and 1.2±0.2 log CFU/g) compared to the DMSO group (8.8±0.1 log CFU/g; P<0.01), which is more than that of the CuSO₄-treated group (reduction of 0.05±0.01 log CFU/g compared to DMSO group) but less than the reduction observed for the streptomycin-treated group (reduction of 1.7±0.8 log CFU/g compared to DMSO-treated group; P<0.01). Treatment with most PCs (n=8/10) did not significantly reduce disease incidence (100%) and was comparable to that of the DMSO- and CuSO₄-treated groups (100%; P<0.01; Table 5). However, treatment with PC5 and PC7 resulted in significantly lower disease incidence (86%) at 7 dpi compared to the DMSO-treated groups (100%; P<0.01; Table 5). The streptomycin-treated group showed the lowest disease incidence of 71%.

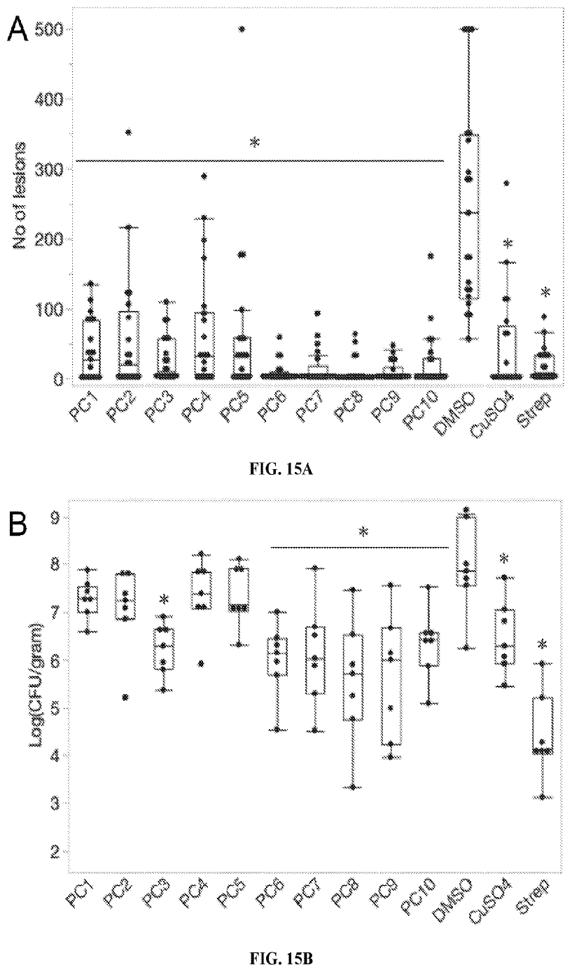

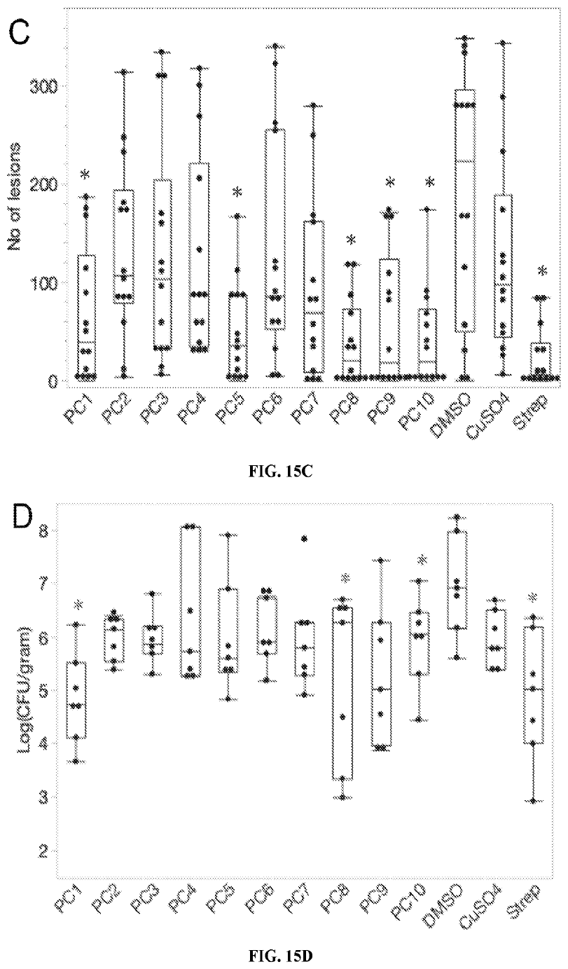

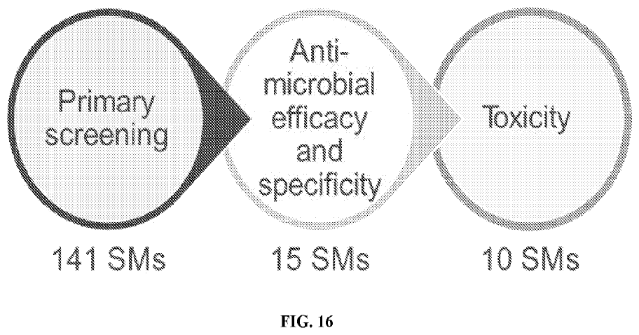

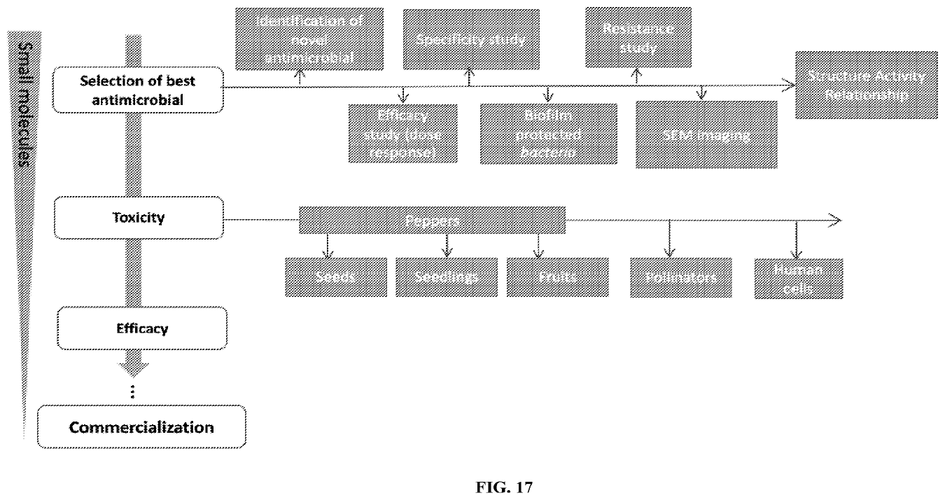

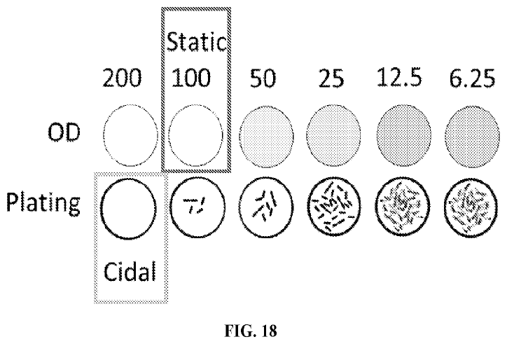

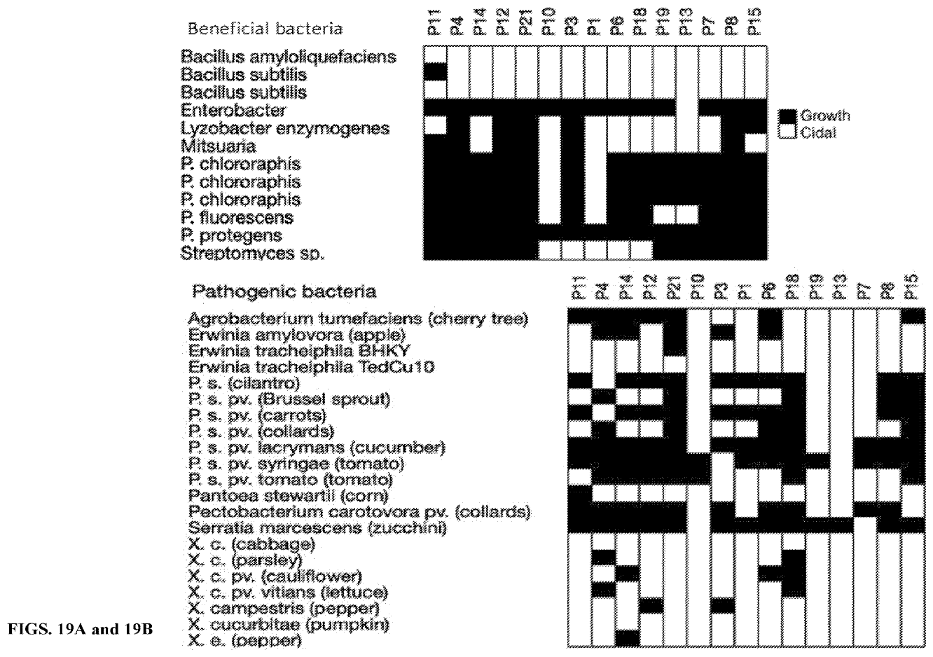

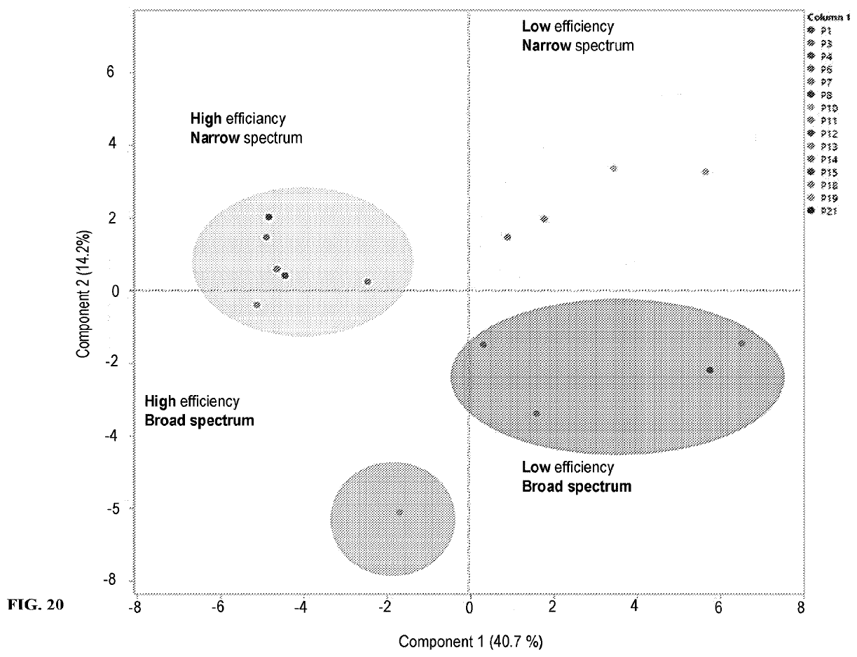

Overall, PC8, PC9, and PC10 displayed antimicrobial activity (significant reduction of disease severity and bacterial load) against Pss in infected pepper seedlings using either a preventive or curative approach. PC3, PC6, PC7, and PC10 also are used (significant reduction of disease severity and bacterial load in the curative experiment only) to manage Pss in planta using a curative approach. PC1 can be used (significant reduction of disease severity and bacterial load when applied preventatively) to manage Pss in planta using a preventive approach. The efficacy of the ten PCs against Pss in inoculated seedlings were investigated twice, however unequal variance was observed between the two trials. For the second trial, although similar efficacy of the PCs was observed against Pss in seedlings, the bacterial load and disease severity were lower, even in the DMSO-treated group (FIG. 15).

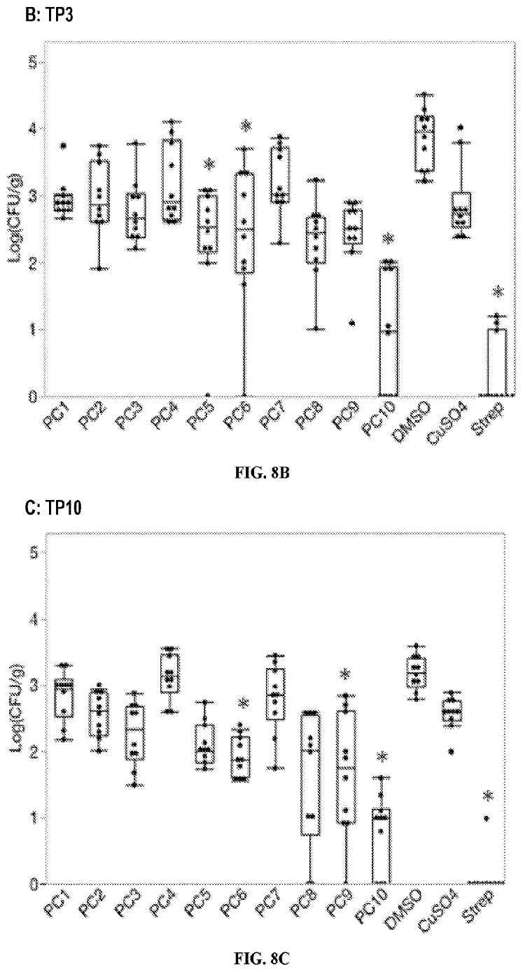

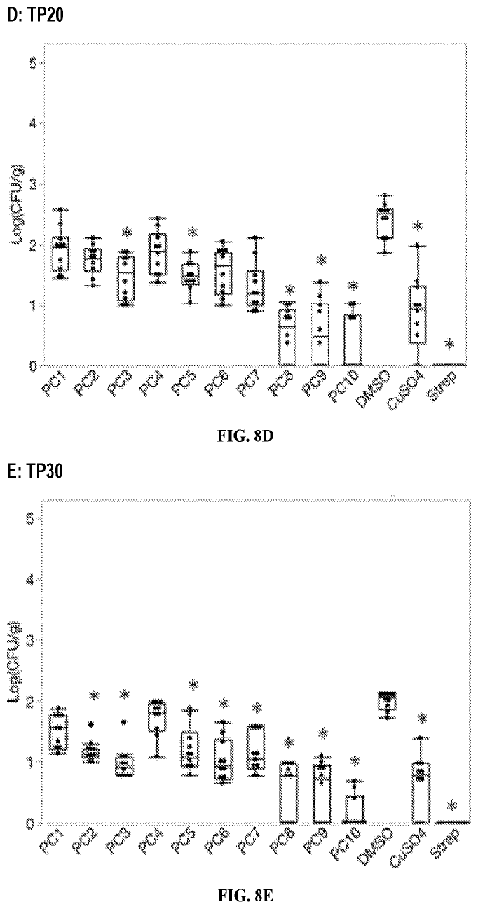

Eight of the selected PCs significantly reduced Pss load in infested pepper seeds at 200 μM over 30 days. Most PCs caused a reduction in the bacterial load on Pss-infested pepper seeds over 30 days (FIG. 8). Seeds treated with PC3, PC5, PC7, PC8, PC9, and PC10 showed significant reduction in Pss load (between 0.9±0.1 and 2.2±0.5 log CFU/g; P<0.01) at 20 days post infestation (dpi) compared to the DMSO-treated group (2.4±0.3 log CFU/g; FIG. 8D). The reduction in bacterial load in seeds treated with PC8, PC9, or PC10 was higher than or equivalent to the reduction in seeds treated with CuSO₄ (1.9±0.5 log CFU/g). Similar trends in bacterial load reduction were observed with PC-treated seeds at other time points as well (FIG. 8). PC10 consistently reduced the bacterial load significantly across all time points and caused the highest bacterial load reduction at 30 dpi (1.9±0.2 log CFU/g) compared to the DMSO-treated group (2.0±0.3 log CFU/g; FIG. 8D). This Pss load reduction was statistically equivalent to the reduction seen in the streptomycin-treated group (2.0±0 log CFU/g; P<0.01). Overall, eight PCs significantly reduced bacterial load in infested seeds across different time points over a 30-day storage period.

Structural Activity Relationship and Chemical functional groups. Fifteen PCP were significantly associated with antimicrobial activity of the PCs by SAR analysis of 60 PCP and in vitro and in planta experimental data (P<0.01, Table 1). Specifically, the PCs with higher numbers of atoms (r2=−0.7), aromatic groups (r2=−0.6 to −0.8), amines (R2NH, r2=−0.7) and hydrogen bond donors (HBD, r2=−0.6 to −0.7) showed increased efficacy against Pss in infested seeds and inoculated seedlings. On the other hand, PCs with higher numbers of charges (r2=0.6 to 0.7), carbon (r2=0.6) and chloride atoms (r2=0.8) and acidic groups (r2=0.7) were associated with decreased efficacy against Pss in seeds and seedlings. PCs with higher numbers of aromatic groups (r2=0.8), carbon atoms (r2=0.6) and heterocycles (r2=0.6) were associated with higher MIC/MBC and MBEC and showed a broader spectrum of activity against plant pathogenic bacteria. Whereas a higher number of hydrogen bond acceptors (HBA, r2=−0.7) and topological polar surface area (TPSA, r2=−0.7 to −0.8) were associated with a narrower spectrum of activity. PCs with higher numbers of ester groups (R—COO—R, r2=−0.7), rings and heterocycles (12=−0.7) were associated with lower toxicity in pepper seeds and human Caco-2 cells. On the other hand, PCs with higher number of halogens like chloride (r2=0.6 to 0.7) and lipophilicity (r2=0.8) were associated with increased toxicity in honeybees and seeds, respectively.

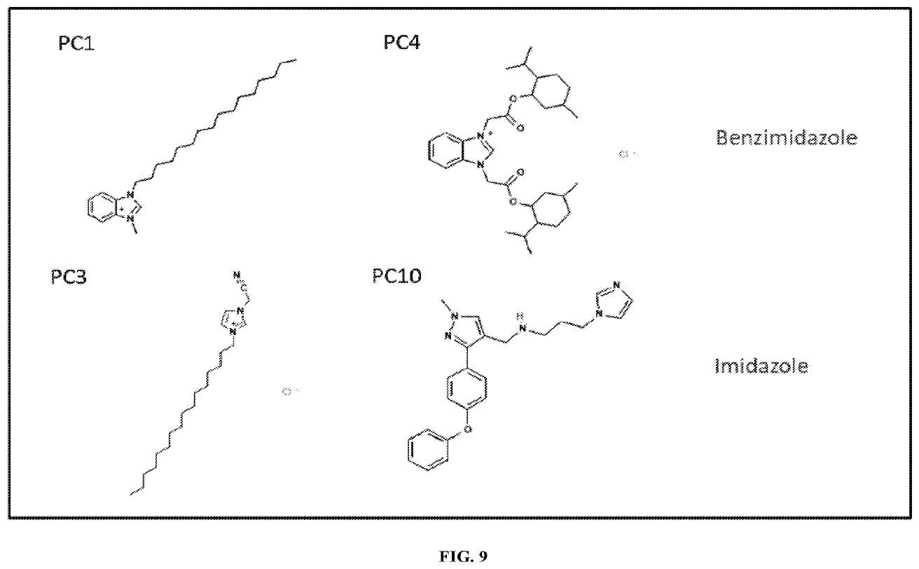

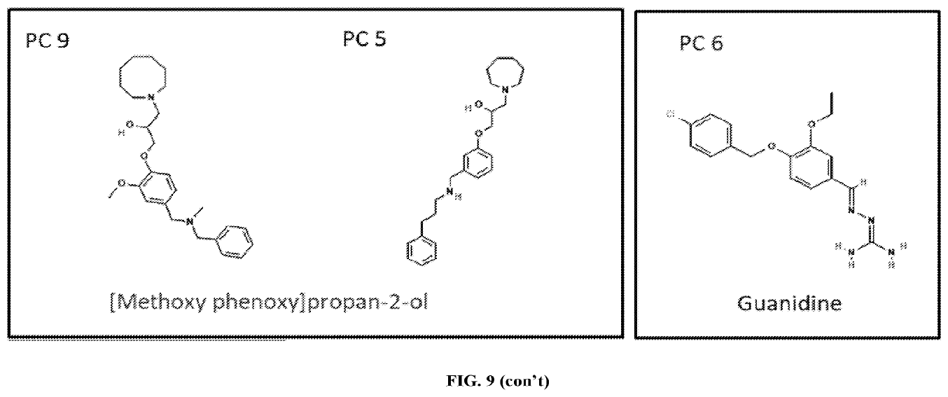

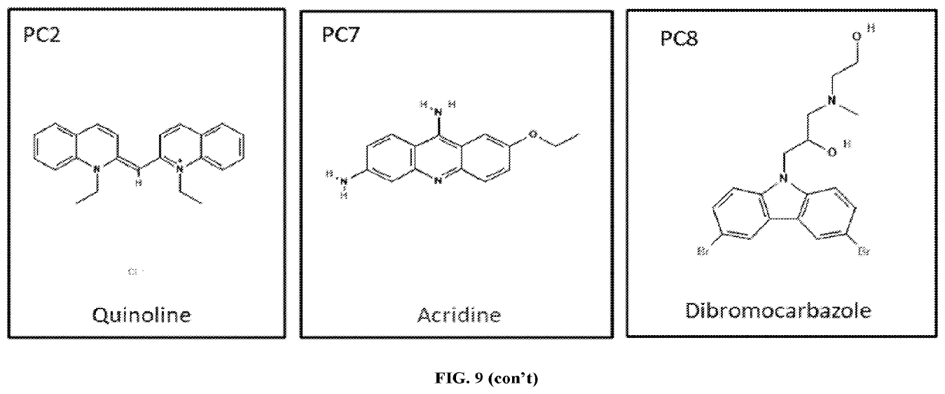

The two-dimensional structural analysis based on Tanimoto scoring of the ten PCs did not show distinct clusters indicating that the structural Tanimoto scoring system does not explain the antimicrobial activity of these PCs. The chemical structures of the PCs were extracted using ChemBridge Hit2lead and PubChem websites. Based on the functional chemical groups, the PCs clustered into six distinct chemical functional groups (FIG. 9). Each functional group has been shown to have antimicrobial activity against various pathogenic bacteria. Cluster A contained the most PCs (n=4, PC1, PC4, P3 and P10) with benzimidazole/imidazole as their common functional group. Cluster B contained PC9 and PC5 with [methoxyphenoxy]propan-2-ol as their common functional group. The remaining clusters each only contained one PC with distinct chemical functional groups: Cluster C (PC6): guanidine, Cluster D (PC2): quinoline, Cluster E (PC7): acridine, and Cluster F (PC8): dibromocarbazole.

### DISCUSSION

Several disease management strategies are employed to assure the yield and quality of vegetable crops. Methods including seed sanitation, removing infected leaf litter and debris between seasons, and using resistant cultivars if available can be used to minimize the impact of Pss in the pepper crop. Pepper cultivars vary in susceptibility to PLS and sanitizing seed treatments are not widely adopted. Cultural tactics are not fully effective when environmental conditions are favorable for the disease. Therefore, farmers use an overarching set of antimicrobial measures (e.g., copper- and streptomycin-based antimicrobials) to mitigate Pss in pepper, which is closely associated with the emergence of AMR bacteria and fungi. This example identified ten novel SM (PC1-PC10) inhibitors of Pss in infested pepper seeds and inoculated seedlings. The ten PCs were effective at low concentrations (25 μM-200 μM) against several Pss isolates collected in Ohio, where conventional approaches were ineffective (Pss resistant to 25 μg/ml CuSO₄ and 12.5 μg/ml streptomycin).

Further, Pss SM1042-14R did not develop resistance to the presented compounds in vitro when challenged with a sublethal dose, even after 50 generations, and to lethal doses of PCs. The antimicrobial efficacy of the PCs was not affected by the presence of biofilm, a predominant virulence mechanism enabling Pss and other bacteria to survive on leaf surfaces and confer resistance against antibiotics.

PCs with different common functional chemical groups were effective against Pss in vitro and in planta. Six distinct chemical motifs were identified across the ten PCs (FIG. 9). PC1, PC3, PC4 and PC10 shared a benzimidazole or imidazole chemical motif. Benzimidazole and imidazole are aromatic heterocyclic compounds that have desirable electron-rich characteristics. Their ability and readiness to accept or donate protons helps them bind to therapeutic drug targets making benzimidazole and imidazole highly attractive to pharmaceuticals for drug development. Synthetic derivatives of imidazole have shown antimicrobial activity against Gram-negative Pseudomonas aeruginosa, Staphylococcus aureus and E. coli with MICs of 31.2-125 μg/mL.

The antimicrobial potential of PC1 and PC3 against avian pathogenic E. coli (APEC) and S. Typhimurium was demonstrated in chicken models. These compounds were also effective against other foodborne pathogens (EHEC 0157: H7, C. jejuni and Listeria monocytogenes) and animal pathogens (M. gallisepticum) in vitro. Further, mechanistic studies showed that these PCs worked by disrupting the cell membrane, forming vesicle-like structures and pores in APEC (PubChem ID: 5717105) and S. Typhimurium (PubChem ID: 2848076 and 2834410).

PC2 contains a quinoline bioactive heterocyclic compound motif. The antimicrobial properties of quinolines are evident in that many drugs approved for clinical use by the US Food and Drug Administration contain quinoline as a major component. Quinoline derivatives have shown antimicrobial activity against gram-negative and -positive bacteria like E. coli, Streptococcus pneumoniae. Vibrio cholerae, Salmonella typhi, and Clostridium tetani with MICs=62.5-100 μg/ml. A compound (PubChem ID: 5717105) used previously from small molecule library with quinoline as part of its chemical functional group showed antimicrobial activity against Erwinia tracheiphila, Clavibacter michiganensis, Xanthomonas spp., and Campylobacter jejuni.

Methoxy-phenoxy was a chemical motif shared by PC5 and PC9 in this example. A methoxy phenol derivative, dibromo-2′-methoxyphenoxy, has shown antimicrobial activity against C. jejuni at MIC=2 μg/mL, P. aeruginosa at MIC=4 μg/mL, and Streptococcus pneumoniae and L. monocytogenes at MIC=8 μg/mL. PC5 and PC9 (PubChem ID: 45170518 and 45210219), with [phenoxy]-2-propanol as part of their chemical functional groups, have shown efficacy against APEC strains, with MICs as low as 25 μM, in-vitro and in-vivo when tested in chickens. The methoxy phenoxy based compounds were hypothesized, based on SEM imaging, to form pores affecting the integrity of the cell membrane of APEC, resulting in in bactericidal activity of these PCs.

Guanidine was the chemical functional group of PC6 in this example, with already known antimicrobial activity against Gram-negative bacteria. Due to the physiochemical characteristics of guanidine, it has high binding potential to phosphate groups, which contributes to its bactericidal effects against multiple pathogens at a low concentration. Herein, PC6 was among the most inhibitory of the PCs, with low MIC and MBC of 12.5 μM and 25 μM, respectively. Guanidine-based polymers exhibited strong contact-killing of S. aureus and E. coli. PC7 with acridine as its chemical functional group and PC8 with dibromocarbazole as its chemical functional group, both have shown antimicrobial activity against Gram-negative bacteria like P. aeruginosa and E. coli. Overall, the chemical groups identified are extensively described as antimicrobials effective against bacterial infections with recurrent AMR issues. Therefore, these PCs are a reliable alternative to copper- and streptomycin-based products for the management of PLS in peppers.

The SAR analysis showed that 15 PCP significantly correlated with the data. It has been shown that some of the PCPs identified in the example have been associated with increased antimicrobial activity. Aromatic groups were among the properties correlated with higher antimicrobial efficacy of our selected PCs including PC4, PC8 and PC10 in planta. Addition of aromatic groups increased the antimicrobial efficacy of compounds against several Gram-positive and -negative bacteria like E. coli, S. aureus, M. tuberculosis. Increasing aromatic groups increases the hydrophobicity, which allows the compounds to disturb the lipid present in the cell membrane of bacteria. Disruption of the cell membrane makes it more permeable to the compounds, leading to leakage of critical ions and molecules, resulting in cell death. Similarly, the presence of hydrogen bond donors (HBD) was also correlated with higher efficacy of PCs such as PC5-PC8 in planta. HBD are known to increase lipophilicity of compounds, which interfere with and modulate the lipid bacterial membrane.

The antimicrobial efficacy of the ten selected PCs hits was validated on Pss-infested pepper seeds. A total of eight PCs significantly reduced Pss populations in seeds. Infested seeds are one of the major routes of long-distance dispersal of Pss and other seedborne pathogens. Exposure of infested seeds to PCs for 20 min resulted in significant reductions in Pss populations over 30 days. Overall, all PC treatments outperformed CuSO₄, causing significant reductions in bacterial populations compared to CuSO₄-treated seeds. PC8, PC9 and PC10 treatments displayed equivalent antimicrobial activity against Pss in seeds, similar to streptomycin treatment. These results show that the PCs identified can be incorporated during seed coating or seed priming processes given only 20 min of soaking in PCs was sufficient to reduce the Pss bacterial load. It is also important to note that none of the eight PCs negatively impacted the germination of the seeds or quality of the seedlings after a 7-day exposure. Therefore, longer PC exposure during the priming steps (up to 5-7 days) or seed coating steps (between 2 to 3 h) may lead to greater reduction or even complete Pss elimination from seeds.

Similarly, the antimicrobial efficacy of the ten PCs was validated on Pss-inoculated pepper seedlings. Six PCs reduced the Pss bacterial load while all ten PCs reduced disease symptoms. In most cases, PC-treated seedlings displayed no or minimal Pss-symptoms while symptoms were predominant in the DMSO-treated seedlings, which led to premature senescence of the inoculated leaves. It is important to mention that reductions in disease incidence/severity and the bacterial load were observed after a single PC application. It is common to apply copper-based antimicrobials on a weekly basis on pepper seedlings. Therefore, multiple applications of the PCs might enhance protection against Pss on peppers. Further, as by EPA standards, the PC hits were confirmed to have no adverse effects on pepper tissues (fruits and seedlings), pollinator honeybees, or human Caco-2 cells, which show that these PCs may be safe for agriculture use.

A curative application of the PCs was more effective than the preventative application in reducing disease incidence and severity as well as the bacterial load in the foliage. The lower antimicrobial efficacy of the preventive treatment compared to the curative application is due to Pss inoculation after the PC treatment, which has washed some of the PCs from the treated leaves. Nevertheless, the possibility that the PC treatments changed the phytobiome in favor of Pss, or the PCs have been modified by abiotic or biotic factors was not excluded.

This example showed that most of the PCs (n=13/15) are effective against other bacterial pathogens of Solanaceae crops, especially Xanthomonas spp, and pathovars. Interestingly, the selected PCs had limited antimicrobial activity against other pathogenic Pseudomonas species, including Pseudomonas syringae pathovars. There is genetic variation within Pseudomonas syringae pathovars that contributes to the difference in antimicrobial effects of the PCs. A comparative genomic analysis between pathogenic Pseudomonas pathovars leads to identification of potential targets of the selected PCs. PCs did not impact the growth of plant beneficial Pseudomonas species such as P. chlororaphis, P. fluorescens and P. protegens, many of which are utilized as biocontrol agents against plant diseases. For example, the application of P. fluorescens conferred protection against P. syringae pv. tomato in Arabidopsis plants. Beneficial Pseudomonas species provide protection against phytopathogens through microbial competition, by promoting host defense gene expression and through production of antimicrobials against phytopathogens. Since PCs identified did not impact the growth of these beneficial Pseudomonas species, PCs can be combined with these beneficial Pseudomonas species as biocontrol agents to enhance the protection against PLS in pepper. This innovative combination can be a sustainable approach to managing PLS in peppers.

In conclusion, six PCs were identified as effective in managing Pss on seedlings and eight PCs effective in reducing Pss populations on seeds with no adverse effects on the plant host, a human cell line, and pollinators. The antimicrobial efficacy of these PCs was equivalent to the current commercial products (streptomycin and copper-based antimicrobials) available to mitigate Pss in pepper. These PCs can also be used to manage other vegetable diseases caused by Xanthomonas spp., Erwinia spp., Agrobacterium tumefaciens, and Pantoea stewartia species. Further, these PCs can be combined with biocontrol agents to enhance protection against Pss. Consequently, these six to eight PCs represent antimicrobials to manage PLS disease in peppers.

It will be apparent to those skilled in the art that various modifications and variations can be made in the present disclosure without departing from the scope or spirit of the invention. Other embodiments of the disclosure will be apparent to those skilled in the art from consideration of the specification and practice of the methods disclosed herein. It is intended that the specification and examples be considered as exemplary only, with a true scope and spirit of the invention being indicated by the following claims.

### TABLES

TABLE 1
Correlation analysis between physico-chemical properties (PCP)
of ten selected small molecule compounds (PC1-PC10) and their
experimental data (in vitro and in planta) that contribute to
the antimicrobial activity of the PCs. PCPs showing significant
differences compared to the DMSO-treated control are displayed (P <
0.01). HBA: hydrogen bond acceptor; HBD: hydrogen bond donor;
TPSA: topological polar surface area; No.: number; TP: time point
(days); Pss: Pseudomonas syringae pv. syringae. Correlations
between the PCPs and experimental data were determined based on the
bootstrap forest and multivariate correlation analysis.

| | | Physio-chemical | Correlation |
|---|---|---|---|
| | Effect | factor (PCP) | (r2) |
| In planta | Suppression of Pss | No. of aromatic | −0.8 |
| | on seeds -TP1 | groups | |
| In planta | Suppression of Pss | No. of aromatic | −0.7 |
| | on seeds -TP3 | groups | |
| In planta | Suppression of Pss | No. of aromatic | −0.7 |
| | on seeds -TP10 | groups | |
| In planta | Suppression of Pss | No. of aromatic | −0.6 |
| | on seeds -TP20 | groups | |
| In planta | Suppression of Pss | No. of aromatic | −0.7 |
| | on seeds - TP30 | groups | |
| In planta | Suppression of Pss | No. of atoms | −0.7 |
| | on seeds - TP3 | | |
| In planta | Suppression of Pss | No. of R-2NH | −0.7 |
| | on seeds - TP3 | | |
| In planta | Suppression of Pss | No. of charges | 0.6 |
| | on seeds - TP10 | | |
| In planta | Suppression of Pss | No. of charges | 0.7 |
| | on seeds - TP20 | | |
| In planta | Suppression of Pss | No. of acidic | 0.6 |
| | on seeds - TP10 | groups | |
| In planta | Suppression of Pss | No. of acidic | 0.7 |
| | on seeds - TP20 | groups | |
| In planta | Reduction of | No. of C atoms | 0.6 |
| | seedling disease | | |
| | severity - curative | | |
| In planta | Reduction of | No. of Cl atoms | 0.9 |
| | seedling disease | | |
| | severity - | | |
| | preventative | | |
| In planta | Reduction in | No. of HBD | −0.6 |
| | seedling Pss load - | | |
| | curative | | |
| In planta | Reduction in | No. of HBD | −0.6 |
| | seedling disease | | |
| | severity - curative | | |
| In planta | Reduction in | No. of HBD | −0.7 |
| | seedling Pss load - | | |
| | preventative | | |
| In vitro | MBC/MIC/MBEC | No. of aromatic | 0.8 |
| | | groups | |
| In vitro | Inhibition of | No. of C atoms | 0.6 |
| | pathogenic bacteria | | |
| In vitro | Inhibition of | No. of heterocycles | 0.6 |
| | pathogenic bacteria | | |
| In vitro | Inhibition of | No. of HBA | −0.8 |
| | beneficial bacteria | | |
| In vitro | Spectrum of activity | TPSA | −0.7 |
| In vitro | Inhibition of | TPSA | −0.7 |
| | beneficial bacteria | | |
| Toxicity | Seed germination | No. of R-COO-R | −0.7 |
| Toxicity | Seed germination | No. of RINGS | −0.6 |
| Toxicity | Seed germination | Lipophilicity (logP) | 0.8 |
| Toxicity | Toxicity on bees | No. of Cl atoms | 0.7 |
| Toxicity | Toxicity on bees | No. of halogen atoms | 0.7 |
| Toxicity | Toxicity on cells | No. of heterocycles | −0.7 |

TABLE 2
Bacterial strains and growth conditions used. All Pseudomonas syringae pv.
syringae (Pss) strains were grown in M9 minimal medium supplemented with 0.8%
glucose, NBY (Nutrient Yeast Extract broth) or streaked on YDC (Yeast Dextrose
Carbonate) agar medium or NBY (Nutrient) agar medium at 28° C. for 48 h in
an incubator. All Pss strains were isolated in Ohio. The plant pathogenic and
beneficial bacteria were grown in NBY broth or agar medium for 48 h at 28°
C. The sources of the bacterial strains are indicated in the table below.

| Bacterial spp. | Strain | Source |
|---|---|---|
| Pseudomonas syringae pv. syringae | SM914-13 | S. Miller, pepper, 2013 |
| ^{ab}Pseudomonas syringae pv. syringae | SM1038-14 | S. Miller, pepper, 2014 |
| ^{ab}Pseudomonas syringae pv. syringae | SM51-19 | S. Miller, pepper, 2019 |
| ^{ab}Pseudomonas syringae pv. syringae | SM156-18 | S. Miller, pepper, 2018 |
| ^{a}Pseudomonas syringae pv. syringae | SM1031-14 | S. Miller, pepper, 2014 |
| abPseudomonas syringae pv. syringae | SM109-18 | S. Miller, pepper, 2018 |
| ^{a}Pseudomonas syringae pv. syringae | SM1042-14R | S. Miller, pepper, 2014 |
| ^{ab}Pseudomonas syringae pv. syringae | SM155-18 | S. Miller, pepper, 2018 |
| ^{a}Pseudomonas syringae pv. syringae | SM1030-14 | S. Miller, pepper, 2014 |
| ^{a}Pseudomonas syringae pv. syringae | SM04-2018-04 | S. Miller, pepper, 2018 |
| Agrobacterium rhizogenes K599 | C58 | C. Taylor, cherry |
| Erwinia amylovora | MLI90-15 | M. Lewis Ivey, apple |
| Erwinia tracheiphila | BHKY | Saalau Rojas et al. 2013 |
| Erwinia tracheiphila | TedCu10 | Saalau Rojas et al. 2013 |
| Pseudomonas syringae pv. coriandricola | DZ01-05 | S. Miller, parsley, 2005 |
| Pseudomonas syringae pv. coriandricola | SM939-13 | S. Miller, carrot, 2013 |
| Pseudomonas syringae pv. maculicola | SM984-13 | S. Miller, Brussels sprouts, 2013 |
| Pseudomonas syringae pv. maculicola | SM162-10 | S. Miller, collards, 2010 |
| Pseudomonas syringae pv. lacrymans | JSF01-04 | S. Miller, cucumber, 2004 |
| Pseudomonas syringae pv. syringae | SM165-10 | S. Miller, tomato, 2010 |
| Pseudomonas syringae pv. tomato | SM275-10 | S. Miller, tomato, 2010 |
| Pantoea stewartii | DCop3-07 | D. Coplin, corn |
| Pectobacterium carotovora subsp. carotovora | SM171-10 | S. Miller, collards, 2010 |
| Serratia marcescens | SM1794 | S. Miller, zucchini |
| Xanthomonas campestris pv. campestris | SG1-4 | S. Miller, cabbage |
| Xanthomonas campestris pv. vitians | SM68-07 | S. Miller, parsley, 2007 |
| Xanthomonas campestris pv. campestris | SM640-11 | S. Miller, cauliflower, 2011 |
| Xanthomonas campestris pv. vitians | 700b | S. Miller, lettuce |
| Xanthomonas cucurbitae | SM622-11 | S. Miller, pumpkin, 2011 |
| Xanthomonas campestris pv. vesicatoria | SM-34 | S. Miller, pepper |
| Bacillus amyloliquefaciens | BA1 | S. Miller |
| Bacillus subtilis | BS1 | B. McSpadden Gardener |
| Bacillus subtilis | GB03 | Brannen and Kelley, 1997 |
| Lyzobacter enzymogenes | C3 | B. McSpadden Gardener |
| Mitsuaria sp. | H244L5A | B. McSpadden Gardener |
| Pseudomonas chlororaphis | 14B11 | Mavrodi et al. 2012 |
| Pseudomonas chlororaphis | 48B8 | Mavrodi et al. 2012 |
| Pseudomonas chlororaphis | 48G9 | Mavrodi et al. 2012 |
| Pseudomonas fluorescens | SM98-08 | S. Miller, 2008 |
| Pseudomonas protegens | 12H11 | Mavrodi et al. 2012 |
| Streptomyces sp. | S2 | B. McSpadden Gardener |

TABLE 3
Summary of the in vitro and in vivo data of Pseudomonas syringae pv. syringae (Pss, n = 10) strains for
the selection of a model Pss strain for small molecule (SM) screening. Ten Pss strains were collected in Ohio from pepper
plants showing Pseudomonas leaf spot symptoms between 2013-2019. Column 1 (Growth assay) indicates the growth rate
of Pss in limited nutrient conditions after 48 h (M9 broth); the growth curve for each strain is represented in FIG. 10.
Column 2 (motility assay) indicates motility (diameter of halo in mm) in semi-solid agar after 24 h. Column 3 (biofilm assay)
indicates production of biofilm (OD₅₇₀) in M9 broth after 72 h. Column 4 (virulence on seedlings of three pepper cultivars):
low (0-33%), moderate (34-66%), and high (67-100%) indicates disease severity. “NA”: not assessed. SM1042-14R
was selected as the model strain as it was the most virulent across all three pepper cultivars.

| | | | | Virulence on pepper seedlings at 21 DPI | | | | | |
|---|---|---|---|---|---|---|---|---|---|
| Pseudomonas syringae | | | | Mercer | | Paladin | | Playmaker | |
| pv. syringae | Growth | | Biofilm | | Symptom | | Symptom | | Symptom |
| strain | rate | Motility | production | Incidence | severity | Incidence | severity | Incidence | severity |
| SM914-13 | 0.007 | 8.710 | 0.152 | NA | NA | NA | NA | NA | NA |
| SM1038-14 | 0.006 | 6.310 | 0.191 | NA | NA | NA | NA | NA | NA |
| SM109-18 | 0.007 | 6.325 | 0.192 | 100% | 10% | 100% | 20% | 100% | 15% |
| SM155-18 | 0.007 | 6.520 | 0.189 | 90% | 5% | 100% | 10% | 70% | 5% |
| SM156-18 | 0.006 | 8.350 | 0.370 | 100% | 10% | 90% | 5% | 90% | 5% |
| SM51-19 | 0.005 | 6.180 | 0.114 | NA | NA | NA | NA | NA | NA |
| SM1030-14 | 0.005 | 6.495 | 0.234 | 30% | 5% | 70% | 10% | 70% | 5% |
| SM1042-14R | 0.006 | 6.275 | 0.172 | 100% | 17% | 100% | 20% | 100% | 17% |
| SM04-2018-04 | 0.005 | 6.150 | 0.342 | NA | NA | NA | NA | NA | NA |
| SM1031-14 | 0.004 | 6.810 | 0.415 | 100% | 5% | 100% | 10% | 100% | 5% |

TABLE 4
Minimal Inhibitory Concentration (MIC) and Minimal
Bacterial Concentration (MBC) of 15 selected compounds
(PC1-PC15) against 10 strains of Pseudomonas syringae
pv. syringae (Pss). The 10 best compounds
(PCs) had MICs and MBCs within the range of
6.25 μM to 200 μM.

| Pss Strains | PCs | PC1 | PC2 | PC3 | PC4 | PC5 | PC6 | PC7 |
|---|---|---|---|---|---|---|---|---|
| SM914- | MBC | 12.5 | 25 | 25 | 12.5 | 25 | 25 | 50 |
| 13 | MIC | 6.25 | 6.25 | 12.5 | 12.5 | 25 | 25 | 25 |
| SM1038- | MBC | 25 | 25 | 50 | 12.5 | 25 | 50 | 100 |
| 14 | MIC | 12.5 | 12.5 | 25 | 12.5 | 25 | 50 | 50 |
| SM51- | MBC | 12.5 | 50 | 50 | 12.5 | 25 | 50 | 200 |
| 19 | MIC | 6.25 | 6.25 | 25 | 12.5 | 25 | 50 | 50 |
| SM156- | MBC | 12.5 | 25 | 50 | 12.5 | 25 | 50 | 100 |
| 18 | MIC | 6.25 | 6.25 | 25 | 12.5 | 25 | 50 | 50 |
| SM1031- | MBC | 12.5 | 25 | 25 | 12.5 | 25 | 50 | 100 |
| 14 | MIC | 6.25 | 6.25 | 25 | 12.5 | 25 | 50 | 50 |
| SM109- | MBC | 12.5 | 12.5 | 25 | 12.5 | 25 | 50 | 100 |
| 18 | MIC | 6.25 | 12.5 | 25 | 12.5 | 25 | 50 | 50 |
| SM1042- | MBC | 12.5 | 12.5 | 25 | 25 | 25 | 50 | 100 |
| 14R | MIC | 6.25 | 6.25 | 25 | 12.5 | 25 | 25 | 50 |
| SM155- | MBC | 12.5 | 25 | 50 | 25 | 25 | 50 | 100 |
| 18 | MIC | 6.25 | 12.5 | 25 | 12.5 | 25 | 50 | 50 |
| SM1030- | MBC | 25 | 50 | 50 | 12.5 | 25 | 50 | 100 |
| 14 | MIC | 6.25 | 6.25 | 25 | 12.5 | 25 | 50 | 50 |
| SM04- | MBC | 12.5 | 25 | 25 | 25 | 25 | 50 | 100 |
| 2018-04 | MIC | 6.25 | 6.25 | 12.5 | 12.5 | 25 | 25 | 50 |

| Pss Strains | PCs | PC8 | PC9 | PC10 | PC11 | PC12 | PC13 | PC14 | PC15 |
|---|---|---|---|---|---|---|---|---|---|
| SM914- | MBC | 200 | 200 | 200 | 500 | 400 | 300 | 400 | 300 |
| 13 | MIC | 100 | 200 | 200 | 100 | 200 | 200 | 50 | 200 |
| SM1038- | MBC | 200 | 200 | 200 | 500 | 300 | 400 | 400 | 300 |
| 14 | MIC | 100 | 100 | 200 | 100 | 200 | 200 | 50 | 200 |
| SM51- | MBC | 200 | 200 | 200 | 500 | 200 | 300 | 400 | 300 |
| 19 | MIC | 100 | 100 | 200 | 100 | 200 | 200 | 100 | 200 |
| SM156- | MBC | 200 | 200 | 200 | 500 | 500 | 300 | 400 | 400 |
| 18 | MIC | 100 | 200 | 200 | 100 | 400 | 300 | 50 | 200 |
| SM1031- | MBC | 200 | 200 | 200 | 500 | 300 | 300 | 400 | 300 |
| 14 | MIC | 100 | 200 | 200 | 100 | 300 | 200 | 50 | 200 |
| SM109- | MBC | 200 | 200 | 200 | >500 | 400 | 300 | >500 | 300 |
| 18 | MIC | 100 | 100 | 200 | 100 | 200 | 300 | 50 | 200 |
| SM1042- | MBC | 200 | 200 | 200 | 500 | 300 | 300 | 500 | 300 |
| 148 | MIC | 100 | 100 | 200 | 100 | 200 | 300 | 40 | 200 |
| SM155- | MBC | 200 | 200 | 200 | >500 | 400 | 300 | >500 | 300 |
| 18 | MIC | 100 | 100 | 200 | 100 | 200 | 300 | 50 | 200 |
| SM1030- | MBC | 200 | 200 | 200 | >500 | 300 | 300 | >500 | 300 |
| 14 | MIC | 100 | 100 | 200 | 100 | 200 | 300 | 50 | 200 |
| SM04- | MBC | 200 | 200 | 200 | 500 | 300 | 300 | 300 | 300 |
| 2018-04 | MIC | 100 | 100 | 200 | 100 | 200 | 200 | 50 | 200 |

TABLE 5
Incidence of Pseudomonas syringae pv. syringae (Pss)-
infected seedlings treated with one of ten selected compounds
(PC1-PC10). The incidence (%) of symptomatic seedlings was
recorded after PC treatment at 200 μM 7 days post infection (dpi).
Seedlings treated with 2% DMSO, 200 μg/ml streptomycin, 200 μM
CuSO₄ (inoculated) or Phosphate Buffered Saline (PBS) (non-inoculated)
were used as controls.

Pseudomonas leaf spot incidence

| | Preventative | Curative |
|---|---|---|
| Treatment | application | application |
| PC1 | 100% | 86% |
| PC2 | 100% | 86% |
| PC3 | 100% | 86% |
| PC4 | 100% | 100% |
| PC5 | 86% | 100% |
| PC6 | 100% | 57% |
| PC7 | 86% | 57% |
| PC8 | 100% | 57% |
| PC9 | 100% | 71% |
| PC10 | 100% | 71% |
| DMSO | 100% | 100% |
| Strep | 71% | 86% |
| CuSO₄ | 100% | 57% |
| PBS | 0% | 0% |

What is claimed is:

1. A method of treating or preventing a bacterial infection in a plant, the method comprising administering to the plant an effective amount of at least one compound selected from the following: 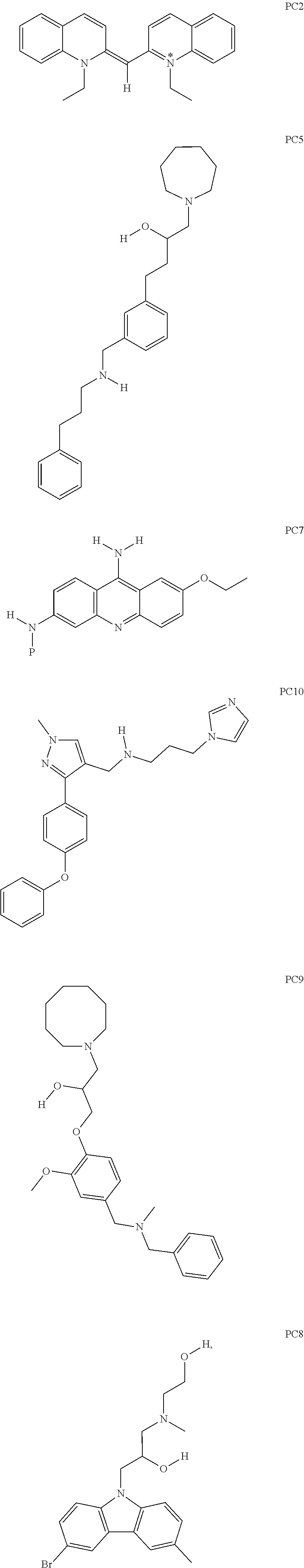
or a derivate thereof.

2. The method of claim 1, wherein the compound comprises PC2.

3. The method of claim 1, wherein the compound comprises PC5.

4. The method of claim 1, wherein the compound comprises PC7.

5. The method of claim 1, wherein the compound comprises PC8.

6. The method of claim 1, wherein the compound comprises PC9.

7. The method of claim 1, wherein the compound comprises PC10.

8. The method of claim 1, wherein the bacterial infection comprises a bacterial pathogen infesting a seed, a seedling, or a developing plant.

9. The method of claim 1, wherein the bacterial infection causes a leaf spot disease.

10. The method of claim 1, wherein the bacterial infection causes a Pseudomonas leaf spot disease or a Xanthomonas leaf spot disease.

11. The method of claim 8, wherein the bacterial pathogen is selected from the group consisting of strains or pathovars of Agrobacterium tumefaciens, Erwinia amylovora, Erwinia tracheiphila, Pseudomonas syringae, Pantoea stewartii, Pectobacterium carotovorum, Serratia marcescens, Xanthomonas campestris, Xanthomonas cucurbitae, and Xanthomonas euvesicatoria.

12. The method of claim 8, wherein the bacterial pathogen comprises Pseudomonas syringae pv. syringae (Pss).

13. The method of claim 8, wherein the seed, seedling, or developing plant are selected from the group consisting of Solanaceae, Leguminosas, Rutaceae, and Rosaceae.

14. The method of claim 1, wherein the compound is administered in combination with a beneficial bacterium.

15. The method of claim 14, wherein the beneficial bacteria is selected from group consisting of Pseudomonas chlororaphis, Pseudomonas fluorescens, and Pseudomonas protegens.

16. The method of claim 1, wherein the plant is a vegetable, fruit, flower, tree, shrub, grass, or grain.

17. The method of claim 1, wherein the plant is a pepper.

18. The method of claim 1, wherein the plant is a tomato.

19. A method of treating or preventing a leaf spot disease in a plant, the method comprising administering to the plant an effective amount of at least one compound selected from the following: 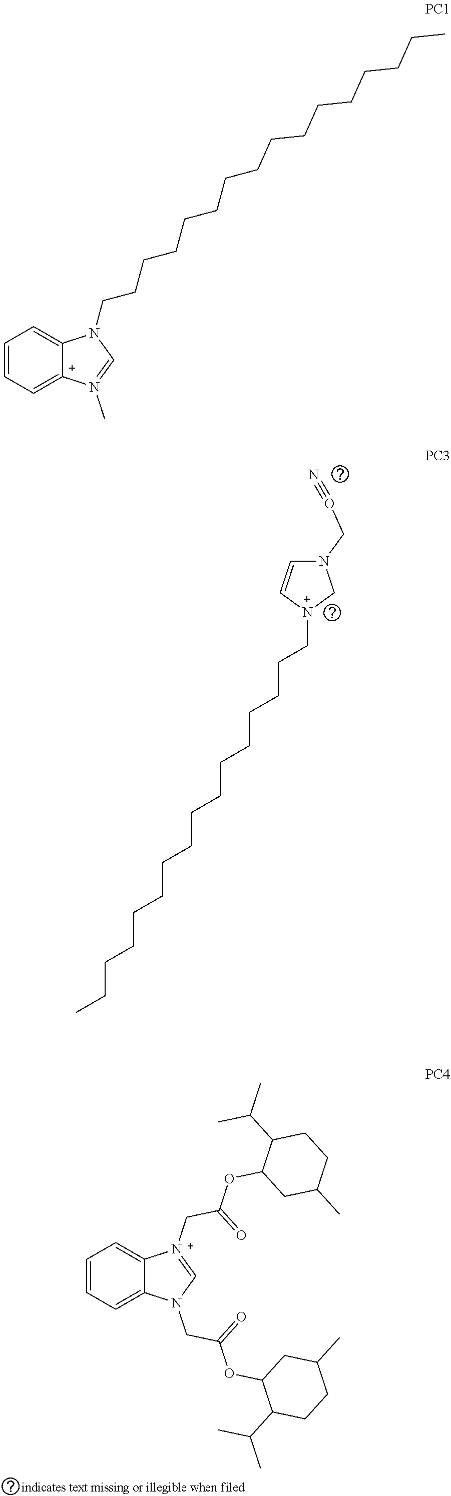 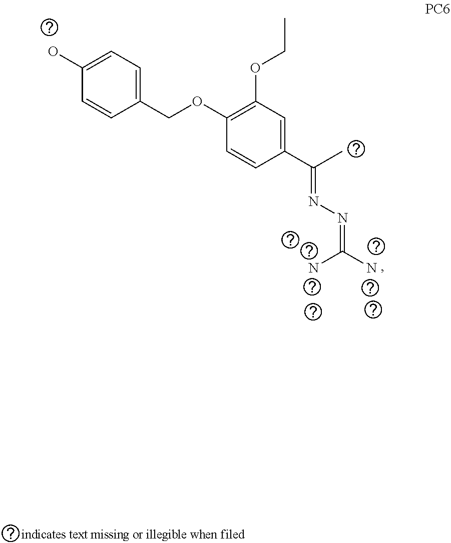 [SMILES: CCOc1cc(/C(C)=N/N=C(N)N)ccc1OCc1ccc(O)cc1]
or a derivative thereof, wherein the leaf spot disease is a Pseudomonas leaf spot disease or a Xanthomonas leaf spot disease.

20.-23. (canceled)

24. The method of claim 19, wherein the leaf spot disease comprises a bacterial pathogen infesting a seed, a seedling, or a developing plant.

25.-31. (canceled)
